(19) United States
(12) Patent Application Publication
(10) Pub. No.: US 2018/0354144 A1
(43) Pub. Date: Dec. 13, 2018

(54) ASSISTED OPENING KNIFE AND RELATED METHOD

(71) Applicant: STANLEY BLACK & DECKER, INC., New Britain, CT (US)

(72) Inventors: Norman John LeBlanc, Davidson, NC (US); Brian M. Chiaruttini, Harwood Heights, IL (US)

(73) Assignee: STANLEY BLACK & DECKER, INC., New Britain, CT (US)

(21) Appl. No.: 16/003,089

(22) Filed: Jun. 7, 2018

Related U.S. Application Data
(60) Provisional application No. 62/516,527, filed on Jun. 7, 2017.

(51) Int. Cl. B26B 5/00; B25G 1/08

(52) U.S. Cl. CPC B26B 5/00; B25G 1/08

(57) ABSTRACT

A knife may include a housing, a blade holder, and an actuator. The blade holder may be movably attached to the housing and configured to receive a blade at least partially within the blade holder. The blade holder may be configured to move relative to the housing between a closed position in which a cutting edge of the blade is positioned entirely within the housing and an open position in which the cutting edge is positioned at least partially outside of the housing. The actuator may be movably attached to the housing and configured to move the blade holder from the closed position toward the open position. The actuator may be configured to move relative to the housing between an extended position in which the actuator is positioned at least partially outside of the housing and a retracted position in which the actuator is positioned entirely within the housing.

### RELATED APPLICATIONS

This application claims priority under 35 U.S.C. § 119 to U.S. Provisional Patent Application No. 62/516,527 filed Jun. 7, 2017, and titled “Assisted Opening Knife and Related Method,” the entire contents of which are hereby incorporated herein by reference for all purposes.

### TECHNICAL FIELD

The present disclosure relates generally to hand tools and methods for using hand tools and more particularly to an assisted opening knife and a related method for moving a blade relative to a handle of the knife between a closed position and an open position.

### BACKGROUND

Various types of knives are known in the art for cutting different objects or workpieces. A knife generally may include a blade for cutting an object and a handle for allowing a user to easily grasp and manipulate the knife during use. Certain knives may include a deployable blade that is movable between a storage position in which the blade is substantially or entirely covered by a housing of the knife and a deployed position in which the blade extends at least partially outside of the housing for cutting an object. For example, certain utility knives may include a housing, which functions as a handle, and a blade configured to translate relative to the housing between a storage position in which the blade is positioned entirely within the housing and a deployed position in which a portion of the blade extends outside of the housing for use. As another example, certain tactical knives may include a housing, which functions as a handle, and a blade configured to pivot relative to the housing between a storage position in which a cutting edge of the blade is positioned within the housing and a deployed position in which the cutting edge extends at least partially outside of the housing for use.

Although conventional utility knives having a translating blade may be suitable for many applications, such knives may present certain problems. For example, certain utility knives may include an actuator to facilitate moving the blade between the storage position and the deployed position, and the actuator may be exposed along the housing when the blade is in the storage position and when the blade is in the deployed position. In this manner, inadvertent contact with the actuator may cause the blade to move from the storage position toward the deployed position or from the deployed position toward the storage position, which may result in user frustration or potential harm to the user. Additionally, for certain utility knives, replacement of the existing blade with a new blade may be a cumbersome and time-consuming process. In particular, blade replacement may require disassembling the housing, removing the existing blade, inserting the new blade, and reassembling the housing. Further, although certain utility knives may include a receptacle within the housing for storing spare blades, insertion of the blades into the receptacle and removal of the blades from the receptacle also may require disassembly and reassembly of the housing. Finally, the housing of certain utility knives may be relatively large compared to the size of the blade, and thus the knife may take up a substantial amount of space in a user's pocket or toolbox even when the blade is in the storage position.

Conventional tactical knives having a pivoting blade also may present certain problems. For example, certain tactical knives may include an actuator to facilitate moving the blade between the storage position and the deployed position, and the actuator may be exposed along the housing when the blade is in the storage position and when the blade is in the deployed position. In this manner, inadvertent contact with the actuator may cause the blade to move from the storage position toward the deployed position or from the deployed position toward the storage position, which may result in user frustration or potential harm to the user. Additionally, the actuator of certain tactical knives may be configured in a manner such that actuation thereof may be challenging, ergonomically undesirable, or not intuitive for certain users.

### BRIEF DESCRIPTION OF THE DRAWINGS

The detailed description is set forth with reference to the accompanying drawings. The use of the same reference numerals may indicate similar or identical items. Various embodiments may utilize elements and/or features other than those illustrated in the drawings, and some elements and/or features may not be present in various embodiments. Elements and/or features in the drawings are not necessarily drawn to scale. Throughout this disclosure, depending on the context, singular and plural terminology may be used interchangeably.

FIG. 1A is a top perspective view of a knife in accordance with one or more example embodiments of the disclosure, with a blade holder of the knife in a closed position relative to a housing of the knife.

FIG. 1B is a side view of the knife of FIG. 1A, with the blade holder in the closed position relative to the housing, according to one example embodiment of the disclosure.

FIG. 1C is a side view of the knife of FIG. 1A, with the blade holder in the closed position relative to the housing, according to one example embodiment of the disclosure.

FIG. 1D is a top view of the knife of FIG. 1A, with the blade holder in the closed position relative to the housing, according to one example embodiment of the disclosure.

FIG. 1E is a bottom view of the knife of FIG. 1A, with the blade holder in the closed position relative to the housing, according to one example embodiment of the disclosure.

FIG. 1F is a top perspective view of the knife of FIG. 1A, with the blade holder in an open position relative to the housing, according to one example embodiment of the disclosure.

FIG. 1G is a side view of the knife of FIG. 1A, with the blade holder in the open position relative to the housing, according to one example embodiment of the disclosure.

FIG. 1H is a side view of the knife of FIG. 1A, with the blade holder in the open position relative to the housing, according to one example embodiment of the disclosure.

FIG. 1I is a top view of the knife of FIG. 1A, with the blade holder in the open position relative to the housing, according to one example embodiment of the disclosure.

FIG. 1J is a bottom view of the knife of FIG. 1A, with the blade holder in the open position relative to the housing, according to one example embodiment of the disclosure.

FIG. 1K is a partially-exploded top perspective view of the knife of FIG. 1A, according to one example embodiment of the disclosure.

FIG. 1L is a partially-exploded top perspective view of the knife of FIG. 1A, according to one example embodiment of the disclosure.

FIG. 1M is an exploded top perspective view of a blade holder assembly and a blade of the knife of FIG. 1A, according to one example embodiment of the disclosure.

FIG. 1N is an exploded top perspective view of the blade holder assembly and the blade of the knife of FIG. 1A, according to one example embodiment of the disclosure.

FIG. 1O is an exploded top perspective view of a housing assembly of the knife of FIG. 1A, according to one example embodiment of the disclosure.

FIG. 1P is an exploded top perspective view of the housing assembly of the knife of FIG. 1A, according to one example embodiment of the disclosure.

FIG. 1Q is a side view of a portion of the knife of FIG. 1A, with the blade holder in the closed position relative to the housing, according to one example embodiment of the disclosure.

FIG. 1R is a side view of a portion of the knife of FIG. 1A, with the blade holder in the closed position relative to the housing, according to one example embodiment of the disclosure.

FIG. 1S is a side view of a portion of the knife of FIG. 1A, with the blade holder in the open position relative to the housing, according to one example embodiment of the disclosure.

FIG. 1T is a side view of a portion of the knife of FIG. 1A, with the blade holder in the open position relative to the housing, according to one example embodiment of the disclosure.

FIG. 1U is a side view of the knife of FIG. 1A, with the blade holder in a partially open position relative to the housing and a door of the knife in an open position relative to the housing, according to one example embodiment of the disclosure.

FIG. 1V is a side view of a portion of the knife of FIG. 1A, with the blade holder in the partially open position relative to the housing and the door in the open position relative to the housing, according to one example embodiment of the disclosure.

FIG. 1W is a side view of a portion of the knife of FIG. 1A, with the blade holder in the open position relative to the housing and the door in a closed position relative to the housing, according to one example embodiment of the disclosure.

FIG. 1X is a side view of a portion of the knife of FIG. 1A, with the blade holder in the closed position relative to the housing and the door in the closed position relative to the housing, according to one example embodiment of the disclosure.

FIG. 2A is a top perspective view of a knife in accordance with one or more example embodiments of the disclosure, with a blade of the knife in a closed position relative to a housing of the knife.

FIG. 2B is a side view of the knife of FIG. 2A, with the blade in the closed position relative to the housing, according to one example embodiment of the disclosure.

FIG. 2C is a side view of the knife of FIG. 2A, with the blade in the closed position relative to the housing, according to one example embodiment of the disclosure.

FIG. 2D is a top view of the knife of FIG. 2A, with the blade in the closed position relative to the housing, according to one example embodiment of the disclosure.

FIG. 2E is a bottom view of the knife of FIG. 2A, with the blade in the closed position relative to the housing, according to one example embodiment of the disclosure.

FIG. 2F is a top perspective view of the knife of FIG. 2A, with the blade in an open position relative to the housing, according to one example embodiment of the disclosure.

FIG. 2G is a side view of the knife of FIG. 2A, with the blade in the open position relative to the housing, according to one example embodiment of the disclosure.

FIG. 2H is a side view of the knife of FIG. 2A, with the blade in the open position relative to the housing, according to one example embodiment of the disclosure.

FIG. 2I is a top view of the knife of FIG. 2A, with the blade in the open position relative to the housing, according to one example embodiment of the disclosure.

FIG. 2J is a bottom view of the knife of FIG. 2A, with the blade in the open position relative to the housing, according to one example embodiment of the disclosure.

FIG. 2K is a partially-exploded top perspective view of the knife of FIG. 2A, according to one example embodiment of the disclosure.

FIG. 2L is a partially-exploded top perspective view of the knife of FIG. 2A, according to one example embodiment of the disclosure.

FIG. 2M is an exploded top perspective view of a housing assembly of the knife of FIG. 2A, according to one example embodiment of the disclosure.

FIG. 2N is an exploded top perspective view of the housing assembly of the knife of FIG. 2A, according to one example embodiment of the disclosure.

FIG. 2O is a side view of a portion of the knife of FIG. 2A, with the blade in the closed position relative to the housing, according to one example embodiment of the disclosure.

FIG. 2P is a side view of a portion of the knife of FIG. 2A, with the blade in the closed position relative to the housing, according to one example embodiment of the disclosure.

FIG. 2Q is a side view of a portion of the knife of FIG. 2A, with the blade in the open position relative to the housing, according to one example embodiment of the disclosure.

FIG. 2R is a side view of a portion of the knife of FIG. 2A, with the blade in the open position relative to the housing, according to one example embodiment of the disclosure.

### DETAILED DESCRIPTION OF EXAMPLE EMBODIMENTS

Described below are example embodiments of a knife, individual components and features of the knife, as well as removable, replaceable blades that can be used in conjunction with the example knife. The knife may be a utility knife for use in various applications for cutting different objects or workpieces. As described below, in certain example embodiments, the knife may include a housing, a blade holder for receiving and retaining a blade therein, and an actuator for moving the blade holder and the blade relative to the housing from a closed or storage position toward an open or deployed position. The blade holder may be configured such that a cutting edge of the blade is positioned entirely within the housing when the blade holder is in the closed position, and such that the cutting edge is positioned at least partially outside of the housing when the blade holder is in the open position. The actuator may movable relative to the housing between an extended position in which the actuator is positioned at least partially outside of the housing and a retracted position in which the actuator is positioned entirely within the housing. In certain example embodiments, the knife may include a blade locking mechanism for releasably locking the blade relative to the blade holder. The blade locking mechanism may be movable between a locked configuration and an unlocked configuration only when the blade holder is in a partially open position. Further, in certain example embodiments, the knife may include a blade storage receptacle defined within the housing for receiving and storing spare blades therein, and a door for accessing the blade storage receptacle. The door may be movable relative to the housing between a closed position for retaining the spare blades within the storage receptacle and an open position for inserting blades into or removing blades from the storage receptacle.

As compared to certain existing utility knives, embodiments of the knife described herein may inhibit inadvertent contact with the actuator when the blade holder is in the open position, thereby minimizing incidence of the blade holder and the blade being unintentionally moved from the open position toward the closed position, may allow an existing blade to be quickly and easily replaced with a new blade without disassembly of the housing, may allow spare blades to be inserted into or removed from the storage receptacle without disassembly of the housing, and/or may provide a more compact configuration that takes up less space in a user's pocket or toolbox.

According to one aspect, a knife may include a housing, a blade holder, and an actuator. The blade holder may be movably attached to the housing and configured to receive a blade at least partially within the blade holder. The blade holder may be configured to move relative to the housing between a closed position in which a cutting edge of the blade is positioned entirely within the housing and an open position in which the cutting edge is positioned at least partially outside of the housing. The actuator may be movably attached to the housing and configured to move the blade holder from the closed position toward the open position. The actuator may be configured to move relative to the housing between an extended position in which the actuator is positioned at least partially outside of the housing and a retracted position in which the actuator is positioned entirely within the housing.

In certain example embodiments, the blade holder may be pivotally attached to the housing and configured to pivot relative to the housing between the closed position and the open position. In certain example embodiments, the actuator may be pivotally attached to the housing and configured to pivot relative to the housing between the extended position and the retracted position. In certain example embodiments, the actuator may be configured to move the blade holder from the closed position toward the open position as the actuator moves from the extended position toward the retracted position. In certain example embodiments, the actuator may include a ring and an arm. The ring may be positioned entirely within the housing when the actuator is in the extended position, and the arm may be positioned at least partially outside of the housing when the actuator is in the extended position. In certain example embodiments, the housing may include an aperture defined in a top surface of the housing, and the arm may extend through the aperture when the actuator is in the extended position.

In certain example embodiments, the knife may include a button positioned at least partially within the blade holder and configured to move relative to the blade holder between an extended position and a retracted position. The button may be configured to engage and prevent removal of the blade when the button is in the extended position, and the button may be configured to disengage and allow removal of the blade when the button is in the retracted position. In certain example embodiments, the knife may include a rod positioned at least partially within the blade holder and configured to move relative to the blade holder between an extended position and a retracted position. The rod may be configured to engage and prevent movement of the button from the extended position to the retracted position when the rod is in the extended position, and the rod may be configured to disengage and allow movement of the button from the extended position to the retracted position when the rod is in the retracted position. In certain example embodiments, the knife may include a spring positioned at least partially within the blade holder and configured to bias the rod toward the retracted position. The rod may be configured to assume the extended position when the blade holder is in the closed position and when the blade holder is in the open position, and the rod may be configured to assume the retracted position when the rod is in a partially open position between the closed position and the open position.

In certain example embodiments, the knife may include a door movably attached to the housing and positioned about an aperture defined in the housing. The door may be configured to move relative to the housing between a closed position in which the door covers the aperture and an open position in which the door exposes the aperture and allows access to an interior space of the housing. In certain example embodiments, the knife may include a spare blade holder movably received within the interior space and configured to support a spare blade therein. In certain example embodiments, the spare blade holder may be configured to move relative to the housing between a retracted position in which the spare blade holder is positioned entirely within the housing and an extended position in which the spare blade holder is positioned at least partially outside of the housing. In certain example embodiments, the spare blade holder may be configured to translate relative to the housing between the retracted position and the extended position. In certain example embodiments, the knife may include a first metal slug attached to the housing, a second metal slug attached to the housing, and a magnet attached to the spare blade holder. Magnetic forces between the magnet and the first metal slug may releasably retain the spare blade holder in the retracted position, and magnetic forces between the magnet and the second metal slug may releasably retain the spare blade holder in the extended position. In certain example embodiments, the magnet may be configured to releasably retain the spare blade relative to the spare blade holder. In certain example embodiments, the knife may include a tab movably attached to the spare blade holder. The tab may be configured to move between a retracted position in which the tab extends over a portion of the spare blade holder and an extended position in which the tab extends away from the spare blade holder. In certain example embodiments, the knife may include a spring attached to the spare blade holder and configured to bias the tab toward the extended position. In certain example embodiments, the door may be configured to move the tab from the extended position to the retracted position when the door is moved from the open position to the closed position. In certain example embodiments, the door may be configured to move the spare blade holder from the extended position to the retracted position when the door is moved from the open position to the closed position.

According to another aspect, a knife may include a housing, a blade, a blade holder, and an actuator. The housing may include a first aperture defined therein. The blade may include a cutting edge. The blade holder may be movably attached to the housing and receive the blade at least partially within the blade holder. The blade holder may be configured to move relative to the housing between a closed position in which the cutting edge is positioned entirely within the housing and an open position in which the cutting edge is positioned at least partially outside of the housing. The actuator may be movably attached to the housing and configured to move the blade holder from the closed position toward the open position. The actuator may be configured to move relative to the housing between an extended position in which the actuator extends through the first aperture and is positioned at least partially outside of the housing and a retracted position in which the actuator is positioned entirely within the housing.

In certain example embodiments, the blade holder may be pivotally attached to the housing and configured to pivot relative to the housing between the closed position and the open position, and the actuator may be pivotally attached to the housing and configured to pivot relative to the housing between the extended position and the retracted position. The actuator may be configured to pivot the blade holder from the closed position toward the open position as the actuator pivots from the extended position toward the retracted position. In certain example embodiments, the knife may include a door movably attached to the housing and positioned about a second aperture defined in the housing. The door may be configured to move relative to the housing between a closed position in which the door covers the second aperture and an open position in which the door exposes the second aperture and allows access to an interior space of the housing. In certain example embodiments, the knife may include a spare blade holder movably received within the interior space. The spare blade holder may be configured to move relative to the housing between a retracted position in which the spare blade holder is positioned entirely within the housing and an extended position in which the spare blade holder extends through the second aperture and is positioned at least partially outside of the housing. In certain example embodiments, the knife may include a spare blade positioned within the interior space and supported by the spare blade holder.

According to still another aspect, a knife may include a housing, a blade, and an actuator. The blade may be movably attached to the housing and may include a cutting edge. The blade may be configured to move relative to the housing between a closed position in which the cutting edge is positioned entirely within the housing and an open position in which the cutting edge is positioned at least partially outside of the housing. The actuator may be movably attached to the housing and configured to move the blade holder from the closed position toward the open position. The actuator may be configured to move relative to the housing between an extended position in which the actuator is positioned at least partially outside of the housing and a retracted position in which the actuator is positioned entirely within the housing.

In certain example embodiments, the blade may be pivotally attached to the housing and configured to pivot relative to the housing between the closed position and the open position, and the actuator may be pivotally attached to the housing and configured to pivot relative to the housing between the extended position and the retracted position. The actuator may be configured to pivot the blade from the closed position toward the open position as the actuator pivots from the extended position toward the retracted position. In certain example embodiments, the actuator may include a ring and an arm. The ring may be positioned entirely within the housing when the actuator is in the extended position, and the arm may be positioned at least partially outside of the housing when the actuator is in the extended position.

These and other example embodiments of the disclosure are described in more detail through reference to the accompanying drawings in the detailed description that follows. This brief overview, including section titles and corresponding summaries, is provided for the reader's convenience and is not intended to limit the scope of the claims or the preceding sections. Furthermore, the techniques described above and below may be implemented in a number of ways and in a number of contexts. Several example implementations and contexts are provided with reference to the accompanying drawings, as described below in more detail. However, the following implementations and contexts are but a few of many.

Certain components and features of the knife may be described herein with reference to example embodiments illustrated in the drawings; however, such components and features are not limited to the example embodiments illustrated in the drawings. Certain components and features of the knife may be described herein as having a length extending relative to a particular axis, a width extending relative to a particular axis, and/or a height or thickness extending relative to a particular axis. The respective axes are shown in some of the drawings with respect to the knife and/or components thereof.

Certain components and features of the knife may be described herein using the terms “top,” “bottom,” “front,” “back,” or “side.” It will be understood that these terms are used to describe a relative position of a component or feature of the knife when the knife is in a particular orientation, such as an orientation shown in the drawings. Certain relationships between components or features of the knife may be described herein using the terms “above,” “below,” “in front of,” or “behind.” It will be understood that these terms are used to describe a relative relationship between two or more components or features of the knife when the knife is in a particular orientation, such as an orientation shown in the drawings.

Certain components and features of the knife may be described herein using the terms “first,” “second,” “third,” etc. These terms are used only to distinguish one component or feature from another identical or similar component or feature. For example, a “first” component or feature could be termed a “second” component or feature, and, similarly, a “second” component or feature could be termed a “first” component or feature, without departing from the scope of the disclosure. Additionally, as used herein the term “and/or” includes any and all combinations of one or more of the associated listed items.

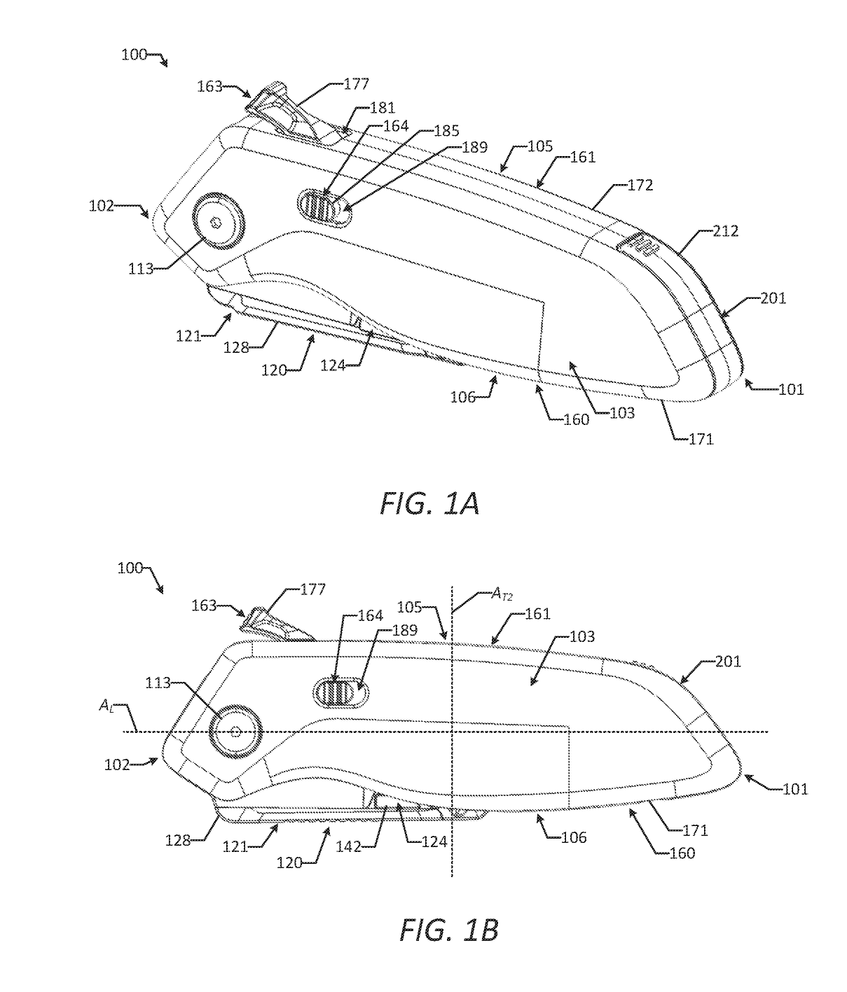

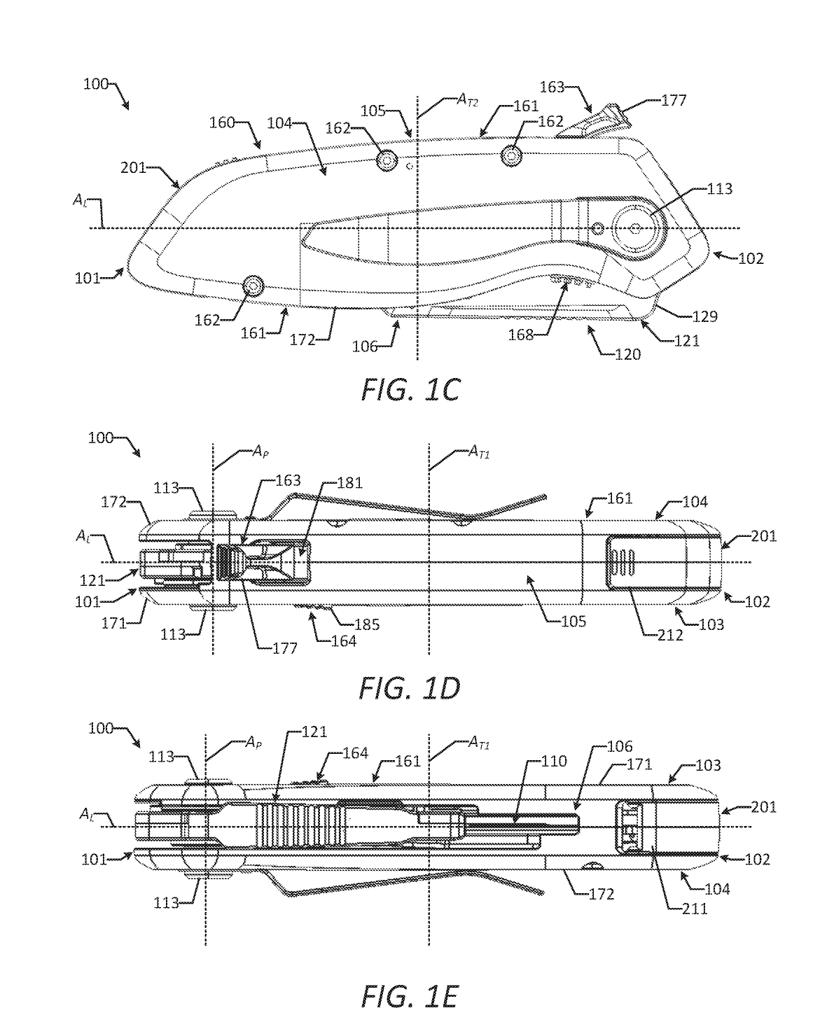

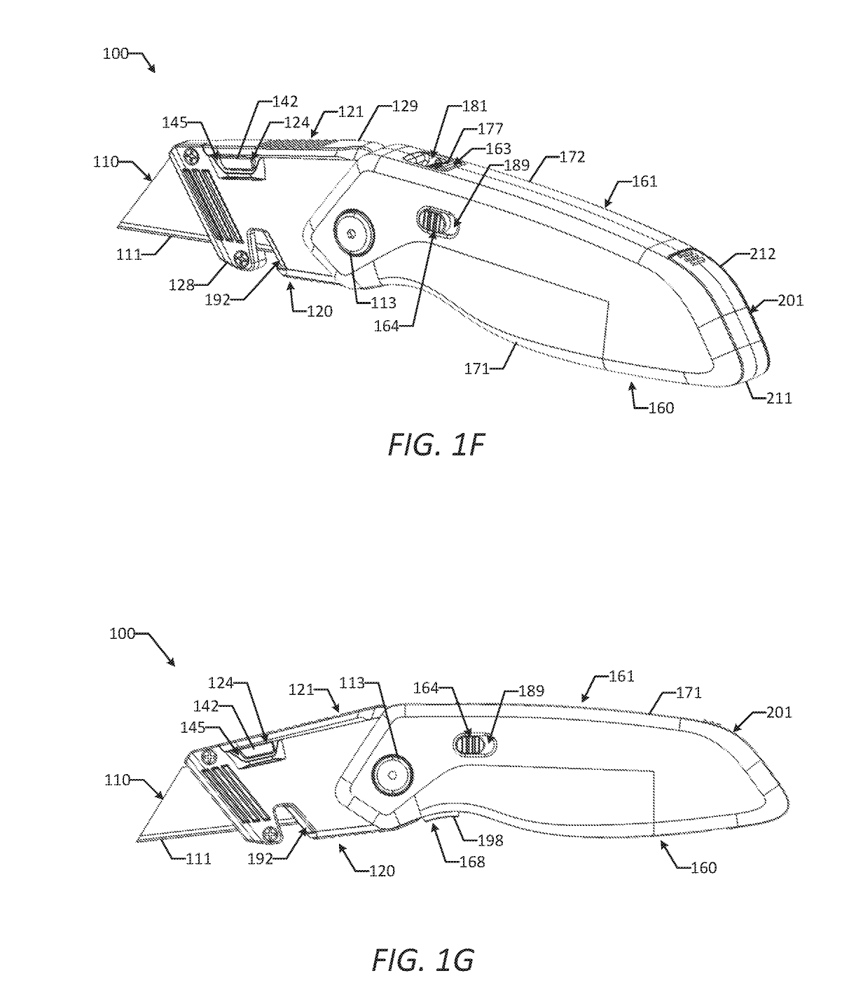

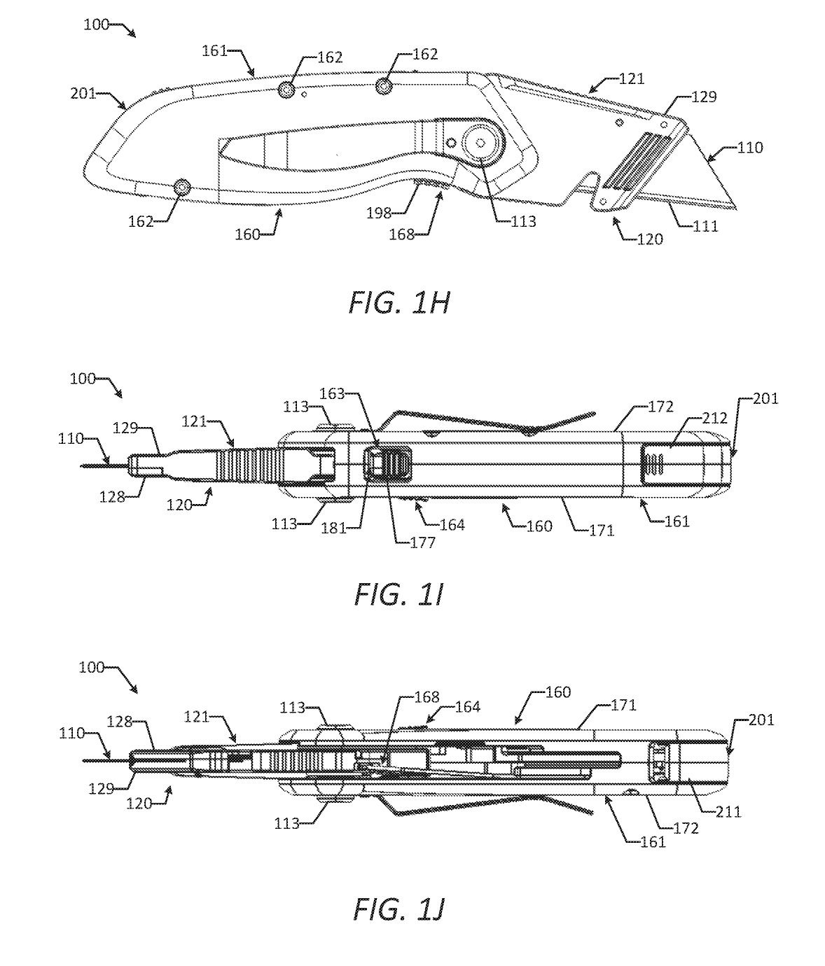

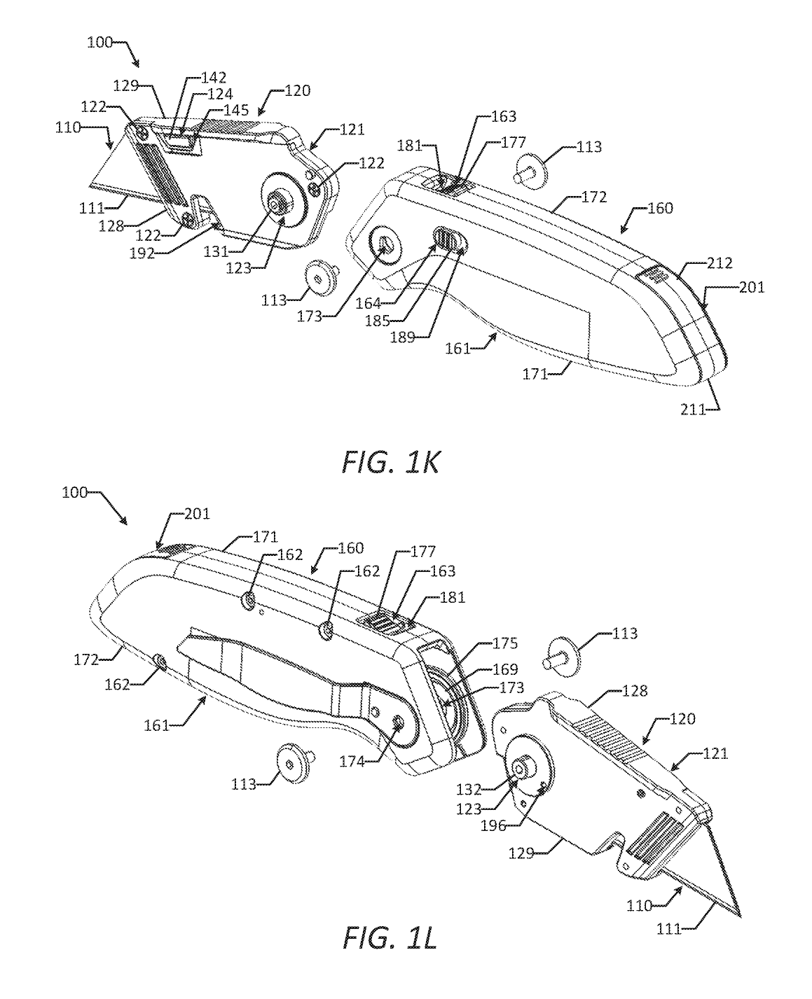

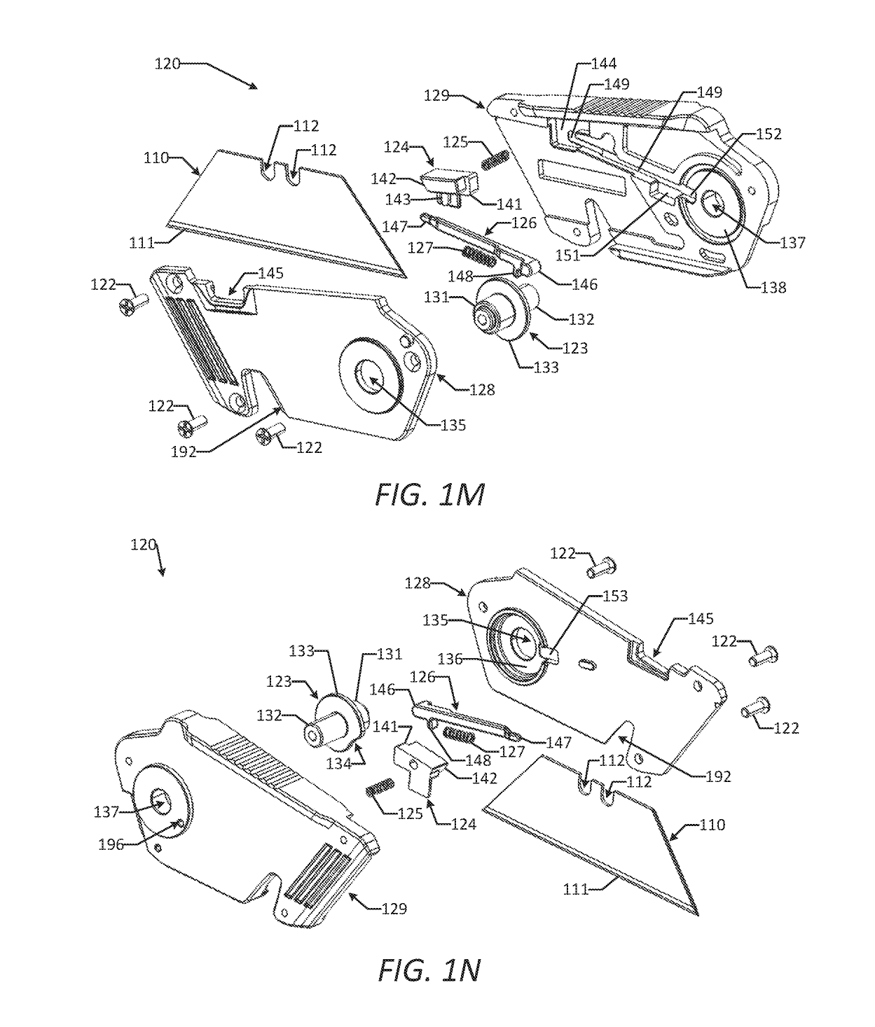

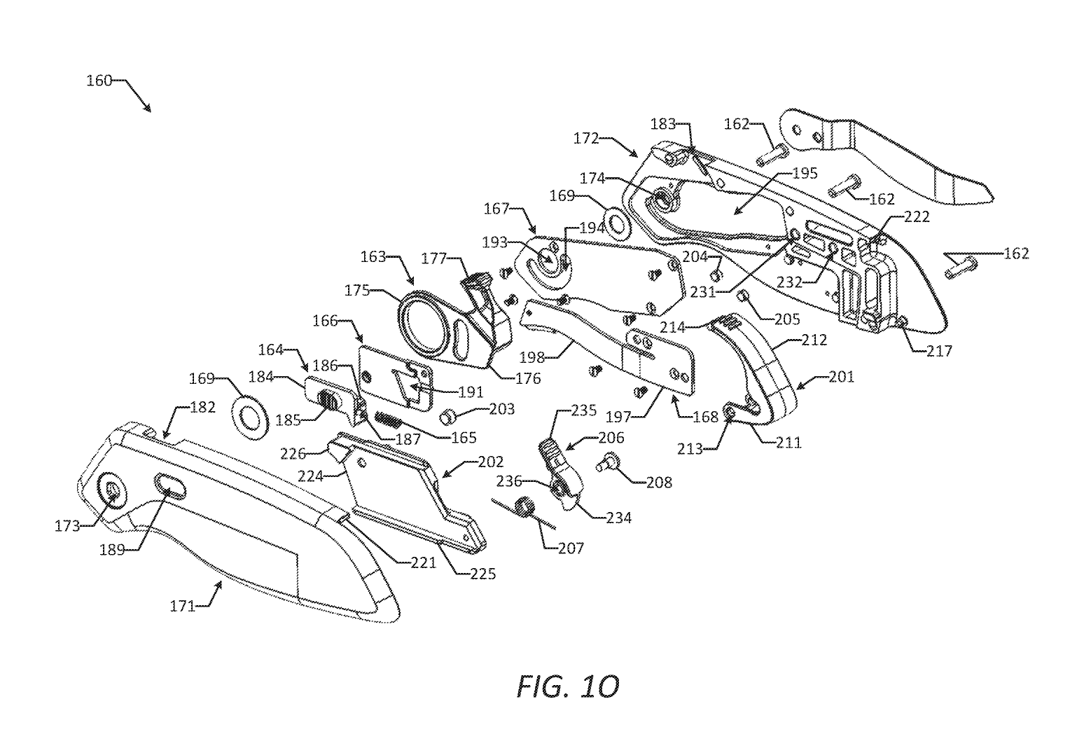

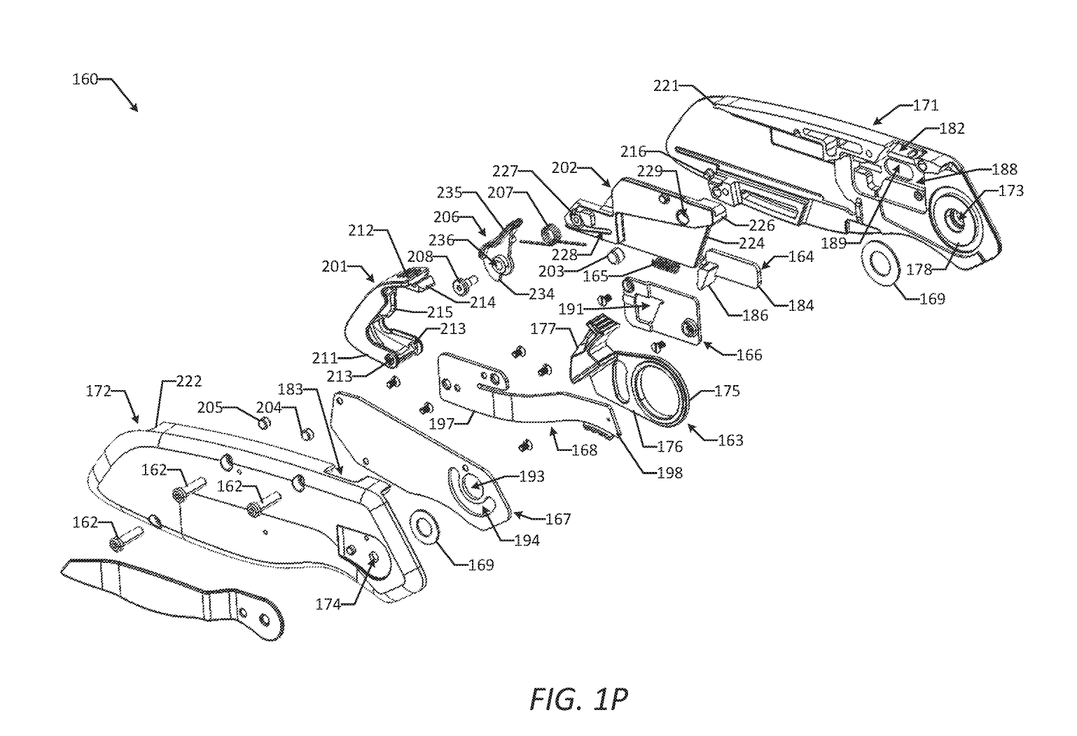

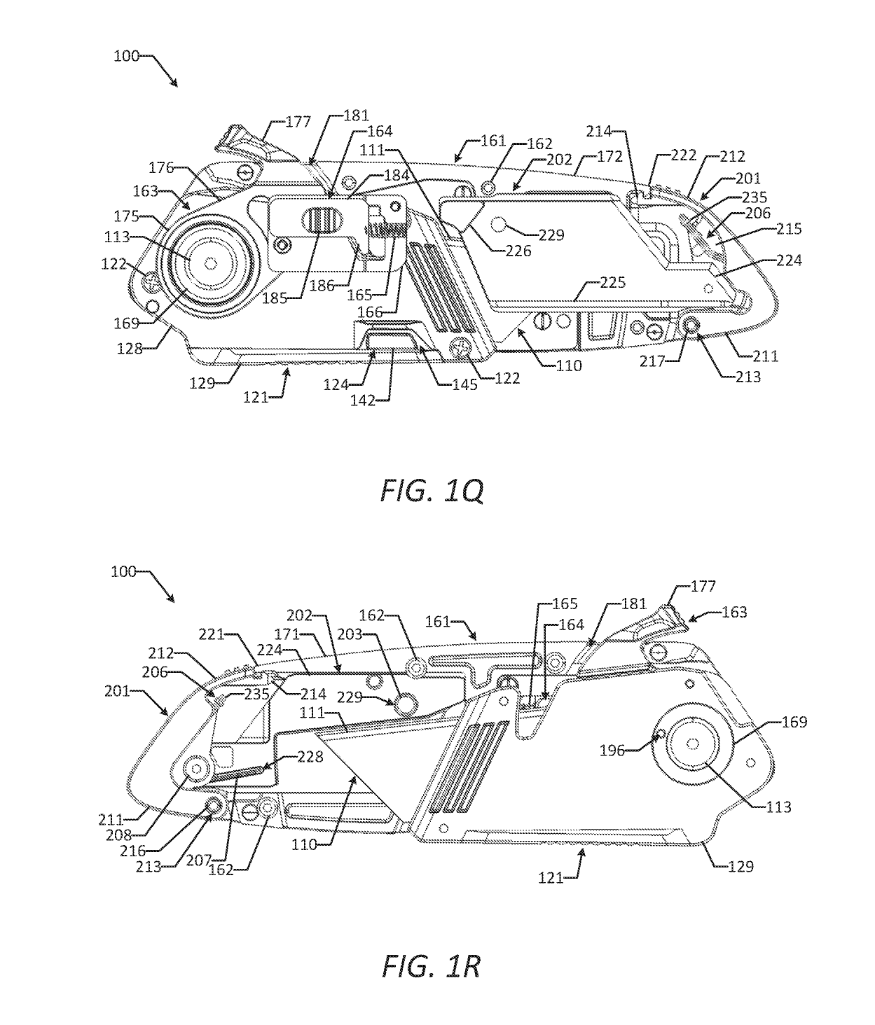

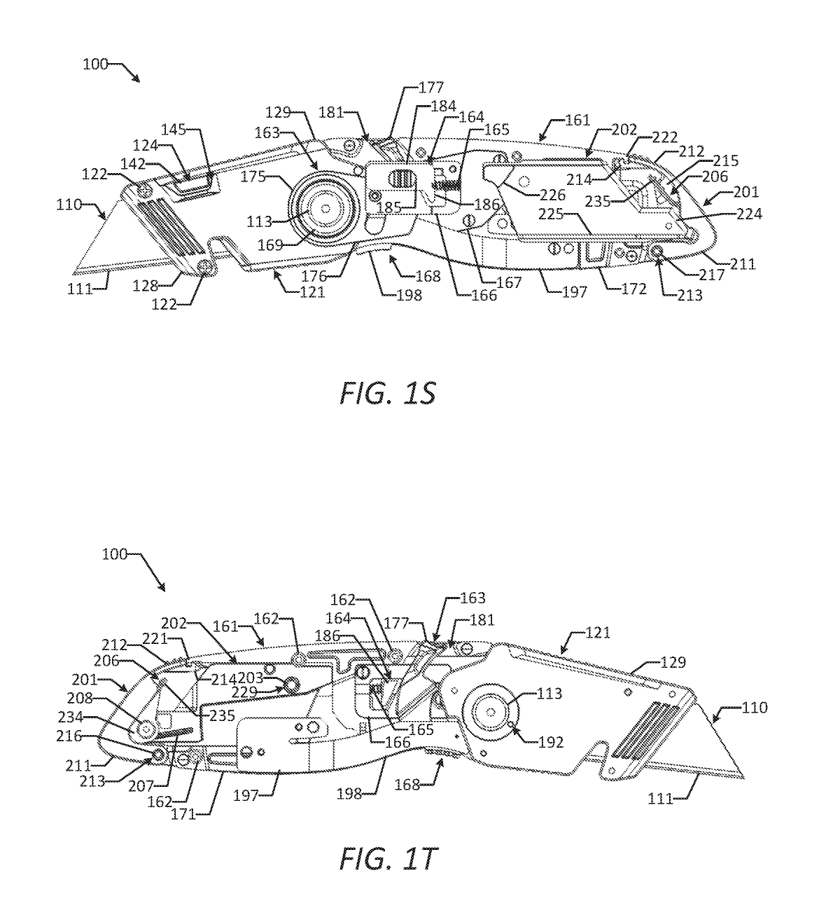

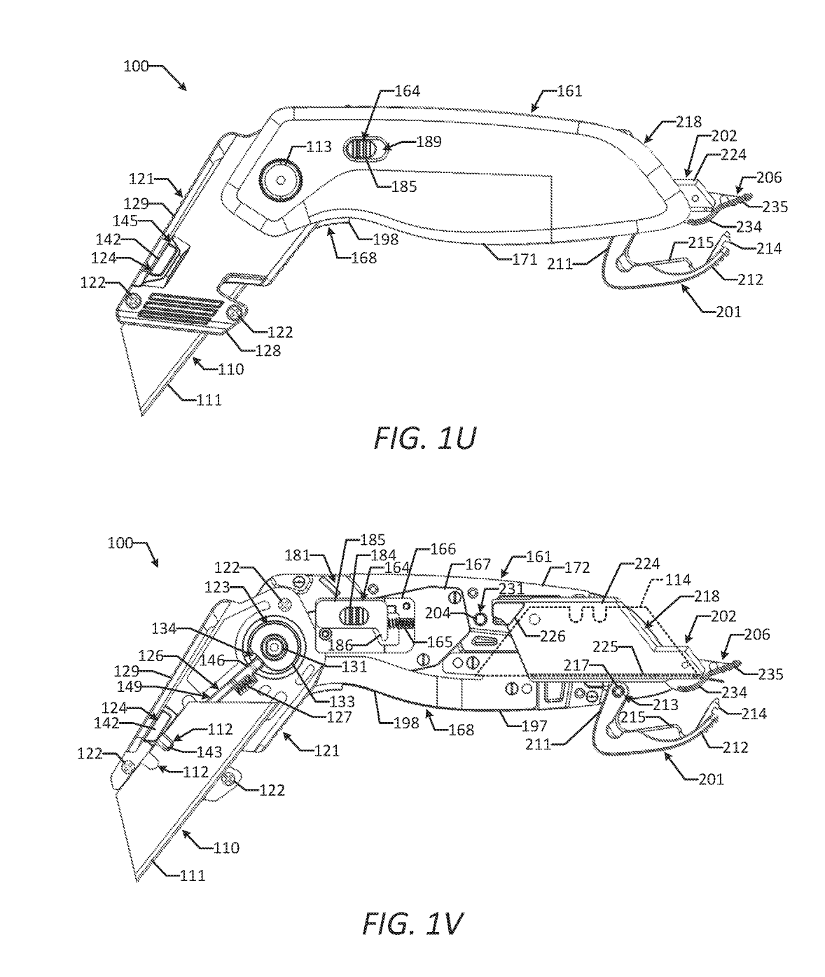

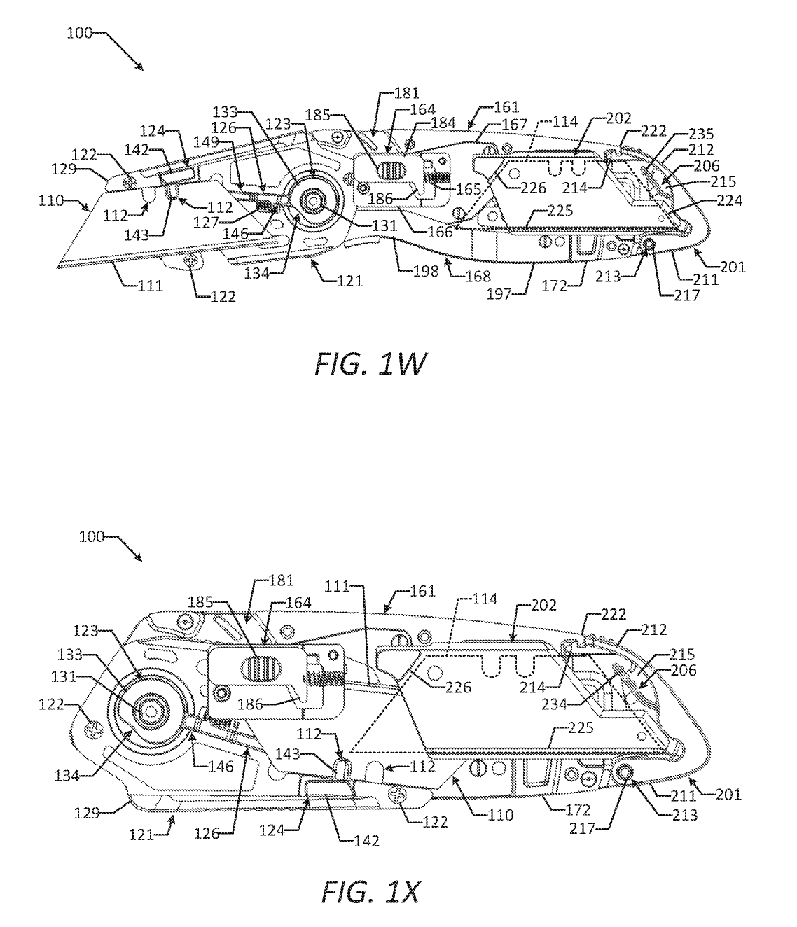

FIGS. 1A-1X illustrate a knife 100 (which also may be referred to as a “assisted opening knife” or a “utility knife”) as well as individual components and features of the knife 100 in accordance with one or more example embodiments of the disclosure. The knife 100 may be used in various applications to cut different objects or workpieces. As described below, the knife 100 may include or may be used in conjunction with one or more removable, replaceable blades having a cutting edge for cutting an object. In this manner, when an existing blade becomes dull or damaged, the blade may be removed and replaced with a new blade for continued use of the knife 100. As described below, the knife 100 may include a housing, a blade holder for receiving and retaining a blade, and an actuator for moving the blade holder relative to the housing from a closed position toward an open position. The knife 100 also may include a blade locking mechanism for releasably locking the blade relative to the blade holder, a blade storage receptacle for receiving and storing spare blades therein, and a door for accessing the blade storage receptacle. As compared to certain existing utility knives, embodiments of the knife 100 described herein may inhibit inadvertent contact with the actuator when the blade holder is in the open position, thereby minimizing incidence of the blade holder and the blade being unintentionally moved from the open position toward the closed position, may allow an existing blade to be quickly and easily replaced with a new blade without disassembly of the housing, may allow spare blades to be inserted into or removed from the storage receptacle without disassembly of the housing, and/or may provide a more compact configuration that takes up less space in a user's pocket or toolbox.

As shown in FIGS. 1A-1X, the example knife 100 may have a generally elongated shape, although various shapes and contours of the knife 100 may be used. The knife 100 may have a length extending in a direction of a longitudinal axis A_{L} of the knife 100, a width extending in a direction of a first transverse axis A_{T1} perpendicular to the longitudinal axis A_{L} of the knife 100, and a height extending in a direction of a second transverse axis A_{T2} perpendicular to each of the longitudinal axis A_{L} and the first transverse axis A_{T1} of the knife 100. As shown, the knife 100 may have a first end 101 (which also may be referred to as a “proximal end” or a “handle end”) and a second end 102 (which also may be referred to as a “distal end” or a “working end”) positioned opposite one another in the direction of the longitudinal axis A_{L} of the knife 100. The knife 100 also may have a first side 103 (which also may be referred to as a “first lateral side”) and a second side 104 (which also may be referred to as a “second lateral side”) positioned opposite one another in the direction of the first transverse axis A_{T1} of the knife 100. Further, the knife 100 may include a third side 105 (which also may be referred to as a “top side”) and a fourth side 106 (which also may be referred to as a “bottom side”) positioned opposite one another in the direction of the second transverse axis A_{T2} of the knife 100. The knife 100 may include a number of components attached, either fixedly or removably, to one another to form the knife 100. In certain example embodiments, as shown, the knife 100 may include one or more blades 110, a blade holder assembly 120, and a housing assembly 160 movably attached to the blade holder assembly 120. The blade holder assembly 120 may be configured to move relative to the housing assembly 160 between a closed position (which also may be referred to as a “storage position”), as shown in FIGS. 1A-1E, and an open position (which also may be referred to as a “deployed position”), as shown in FIGS. 1F-1J. In particular, the blade holder assembly 120 may be configured to pivot relative to the housing assembly 160 between the closed position and the open position. In this manner, the knife 100 may be movable between a closed configuration in which the blade holder assembly 120 is in the closed position relative to the housing assembly 160 and an open configuration in which the blade holder assembly 120 is in the open position relative to the housing assembly 160. It will be appreciated that FIGS. 1A-1X illustrate merely one example embodiment of the knife 100 and that various other configurations of the knife 100 and components thereof may be used.

As shown in FIGS. 1M and 1N, the blade 110 generally may be formed as a conventional utility blade having an elongated trapezoidal shape, although other shapes and configurations of the blade 110 may be used. The blade 110 may include a cutting edge 111 positioned along the bottom side thereof, and one or more apertures 112 defined along the top side thereof. In certain example embodiments, as shown, the apertures 112 may be formed as U-shaped notches extending downward from the top side of the blade 110, although other forms of the apertures 112, such as thru holes, may be used. The blade 110 may be formed of a metal, such as steel, although other materials may be used.

As shown in FIGS. 1A-1L, the blade holder assembly 120 and the housing assembly 160 may be movably attached to one another such that the blade holder assembly 120 may pivot between the closed position and the open position about a pivot axis A_{P} of the knife 100. The blade holder assembly 120 and the housing assembly 160 may be attached to one another by one or more fasteners 113 extending along the pivot axis A_{P}. According to the illustrated embodiment, the knife 100 may include a pair of fasteners 113 formed as screws, although any number of the fasteners 113 and other types of fasteners may be used. As described below, the fasteners 113 may engage and interact with components of the blade holder assembly 120 and the housing assembly 160 to allow the pivotal movement therebetween.

The blade holder assembly 120 may be configured to receive and removably retain the blade 110 for use of the knife 100. In this manner, the blade 110 may be securely retained by the blade holder assembly 120 during use of the knife 100 and may be removed and replaced with a new blade when the blade 110 becomes dull or damaged. As shown in FIGS. 1A-1N, the blade holder assembly 120 may include a blade holder body 121, a number of fasteners 122, an axle 123, a button 124, a first spring 125, a rod 126, and a second spring 127. The blade holder body 121 (which also may be referred to as a “blade holder” or a “blade housing”) may be configured to removably receive a portion of the blade 110 therein. In certain example embodiments, as shown, the blade holder body 121 may include a first body portion 128 and a second body portion 129 attached to one another by the fasteners 122. The fasteners 122 may be formed as screws, although other types of fasteners may be used. As shown, the first body portion 128 and the second body portion 129 may define a receptacle therebetween for removably receiving a portion of the blade 110. The first body portion 128 and the second body portion 129 may include a number of features configured to cooperate with the axle 123, the button 124, the first spring 125, the rod 126, and the second spring 127 to releasably retain the blade 110, as described below.

As shown, the axle 123 may be formed as an elongated, generally cylindrical member configured to extend through the first body portion 128 and the second body portion 129 and facilitate pivotal movement between the blade holder 121 and the housing assembly 160. The axle 123 may include a first end portion 131, a second end portion 132, and a flange 133 positioned between the first end portion 131 and the second end portion 132. The flange 134 may have a generally cylindrical disc shape with a circular circumferentially outer surface along a majority of the circumference thereof and a recess 134 defined in the circumferentially outer surface and having a curved contour. As shown, the first end portion 131 may be positioned at least partially within a first aperture 135 of the first body portion 128, and the flange 133 may be positioned at least partially within a counterbore 136 of the first body portion 128. The second end portion 132 may be positioned at least partially within a first aperture 137 of the second body portion 129, and the flange 133 may abut a boss 138 of the second body portion 129. As described below, axle 123 may be keyed to the housing assembly 160 such that the blade holder 121 pivots relative to the axle 123 about the pivot axis A_{P}.

The button 124 may be configured to releasably engage the blade 110 when the blade 110 is positioned within the blade holder 121. As shown, the button 124 may include a base portion 141, a first protrusion 142 extending laterally from the base portion 141, and a second protrusion 143 extending downward from the base portion 141. The base portion 141 may be positioned at least partially within a first recess 144 of the second body portion 129 and movable therein. The first protrusion 142 may be positioned at least partially within a second aperture 145 of the first body portion 128 and movable therein. As shown, the first spring 125 may be positioned between the second body portion 129 and the button 124 and configured to bias the button 124 away from the second body portion 129 and toward the first body portion 128. In this manner, the button 124 may be movable between an extended position in which the first protrusion 142 extends at least partially through the second aperture 145 of the first body portion 128 and a retracted position in which the first protrusion 142 is positioned closer to the first recess 144 of the second body portion 129. The first spring 125 may be formed as a compression spring, as shown, although other types of springs may be used. The base portion 141 may include a blind hole for retaining a portion of the first spring 125 therein. The button 124 may be actuated by a user pressing the first protrusion 142 and overcoming the biasing force provided by the first spring 125, thereby moving the button 124 from the extended position toward the retracted position. The second protrusion 143 may be configured to releasably engage the blade 110. In particular, the second protrusion 143 may be positioned at least partially within one of the apertures 112 of the blade 110 when the blade 110 is positioned within the receptacle of the blade holder 121 and the button 124 is in the extended position. In this manner, the second protrusion 143 may retain the blade 110 with respect to the blade holder 121 when the button 124 is in the extended position.

The rod 126 may be formed as an elongated member including a number of features for cooperating with the blade holder 121, the axle 123, and the button 124. As shown, the rod 126 may include a first end portion 146, a second end portion 147, and a protrusion 148 extending downward from the first end portion 146. The first end portion 146 and the second end portion 147 may be positioned at least partially within a second recess 149 of the second body portion 129 and movable therein, and the protrusion 148 may be positioned at least partially within a third recess 151 of the second body portion 129 and movable therein. As shown, the second recess 149 may extend between and be in communication with the first recess 144 and the third recess 151 of the second body portion 129. The second recess 149 also may extend into and form a second aperture 152 in the boss 138 of the second body portion 129. The first end portion 146 also may be positioned at least partially within a first recess 153 of the first body portion 128 and movable therein. As shown, the first recess 153 may be in communication with the counterbore 136 of the first body portion 128. The respective portions of the rod 126 may be configured to translate within the second recess 149 and the third recess 151 of the second body portion 129 and within the first recess 153 of the first body portion 128. As shown, the second spring 127 may be positioned at least partially within the third recess 151 and configured to bias the rod 126 toward the axle 123. In particular, the second spring 127 may bias the first end portion 146 of the rod 126 into engagement with the flange 133 of the axle 123. In this manner, the first end portion 146 may engage the flange 133 regardless of the position at which the blade holder 121 is pivoted relative to the axle 123. The rod 126 may be movable between an extended position in which the first end portion 146 is positioned outside of the second aperture 152 of the second body portion 129, the first end portion 146 is positioned outside of the counterbore 136 of the first body portion 128, and the second end portion 147 is positioned at least partially within the first recess 144 of the second body portion 129, and a retracted position in which the first end portion 146 is positioned at least partially within the second aperture 152 of the second body portion 129, the first end portion 146 is positioned at least partially within the counterbore 136 of the first body portion 128, and the second end portion 147 is positioned outside of the first recess 144 of the second body portion 129. The rod 126 may assume the extended position when the first end portion 146 engages the cylindrical portion of the flange 133 of the axle 123, and the rod 126 may assume the retracted position when the first end portion 146 engages the recess 134 of the flange 133. In other words, the second spring 127 may move the rod 126 from the extended position toward the retracted position when the rod 126 is radially aligned with the recess 134 of the flange 133.

The axle 123, the button 124, and the rod 126 may cooperate with one another to control when the blade 110 may be removed from the blade holder assembly 120 and replaced with a new blade. As described above, when the rod 126 is in the extended position, the second end portion 147 thereof may be positioned at least partially within the first recess 144 of the second body portion 129. In this manner, when the rod 126 is in the extended position, the second end portion 147 thereof may prevent the button 124 from moving from the extended position to the retracted position. Accordingly, when the rod 126 is in the extended position, the second protrusion 143 of the button 124 may not be disengaged from the aperture 112 of the blade 110 to allow removal of the blade 110 from the blade holder 121. As described above, when the rod 126 is in the retracted position, the second end portion 147 thereof may be positioned outside of the first recess 144 of the second body portion 129. In this manner, when the rod 126 is in the retracted position, the second end portion 147 thereof may no longer prevent the button 124 from moving from the extended position to the retracted position. Accordingly, when the rod 126 is in the retracted position, a user may press the button 124 such that the second protrusion 143 thereof may disengage the aperture 112 of the blade 110 and allow removal of the blade 110 from the blade holder 121.

The housing assembly 160 may be configured to control movement of the blade holder assembly 120 between the closed position and the open position and to receive at least a portion of the blade holder assembly 120 therein when the blade holder assembly 120 is in the closed position. As shown in FIGS. 1A-1L, 1O, and 1P, the housing assembly 160 may include a housing 161, a number of fasteners 162, an actuator 163, a button 164, a first spring 165, a first plate 166, a second plate 167, a leaf spring 168, and a number of washers 169. The housing 161 (which also may be referred to as a “knife housing” or a “knife body”) may be configured to receive at least a portion of the blade holder 121 and the blade 110 therein when the blade holder 121 is in the closed position. In certain example embodiments, as shown, the housing 161 may include a first housing portion 171 and a second housing portion 172 attached to one another by the fasteners 162. The fasteners 162 may be formed as screws, although other types of fasteners may be used. As shown, the first housing portion 171 and the second housing portion 172 may define a receptacle therebetween for movably receiving at least a portion of the blade holder 121 therein. The first housing portion 171 and the second housing portion 172 may include a number of features configured to cooperate with the actuator 163, the button 164, the first spring 165, the first plate 166, the second plate 167, and the leaf spring 168, as described below. The first housing portion 171 and the second housing portion 172 also may include a number of features configured to cooperate with components of the blade holder assembly 120.

As shown, the axle 123 may be fixedly attached to the housing 161 such that the housing 161 does not pivot relative to the axle 123. The first end portion 131 of the axle 123 may be received at least partially within a first aperture 173 of the first housing portion 171, and the second end portion 132 of the axle 123 may be positioned at least partially within a first aperture 174 of the second housing portion 172. The first end portion 131 of the axle 123 may be keyed to the first aperture 173 of the first housing portion 171 to prevent rotation of the axle 123 relative to the first housing portion 171. For example, the first aperture 173 may have a partially circular shape with a flat edge, and the first end portion 131 may have a mating partially circular shape with a flat edge, as shown, to prevent relative rotation. One of the washers 169 may be positioned over the first end portion 131 and between the flange 133 of the axle 123 and the first housing portion 171, and the other washer 169 may be positioned over the second end portion 132 and between the flange 133 and the second housing portion 172. In view of this configuration, the blade holder 121 may pivot relative to the axle 123 and the housing 161 between the closed position and the open position, as described above.

The actuator 163 may be configured to move the blade holder 121 relative to the housing 161 from the closed position toward the open position. As shown in FIGS. 1O and 1P, the actuator 163 may include a ring 175, a plate 176 extending away from the ring 175, and an arm 177 extending upwardly from the plate 176. The ring 175 may have a circular shape with a central opening extending therethrough and may be positioned coaxially with the axle 123 for pivotal movement about the pivot axis A_{P}. As shown, the axle 123, one of the fasteners 113, one of the washers 169, and a boss 178 of the first housing portion 171 may be positioned at least partially within the central opening of the ring 175. The arm 177 of the actuator 163 may be movably received within a first aperture 181 of the housing 161. As shown, the first aperture 181 may be defined in the top side of the housing 161 and may be collectively formed by a second aperture 182 of the first housing portion 171 and a second aperture 183 of the second housing portion 172. The actuator 163 may be configured to pivot relative to the axle 123 between an extended position in which the arm 177 extends at least partially through the first aperture 181 and outside of the housing 161 and a retracted position in which the arm 177 is positioned entirely within the housing 161. In this manner, when the actuator 163 is in the extended position, the arm 177 may be exposed and engaged by a user, and when the actuator 163 is in the retracted position, the arm 177 may be positioned entirely between the first housing portion 171 and the second housing portion 172. As further described below, the actuator 163 may be configured to move the blade holder 121 relative to the housing 161 from the closed position toward the open position. When the actuator 163 is in the extended position and the blade holder 121 is in the closed position, the actuator 163 may engage the blade 121. In particular, a bottom side of the arm 177 may engage the blade holder 121 when the actuator 163 is in the extended position and the blade holder 121 is in the closed position. As the actuator 163 pivots about the axle 123 from the extended position to the retracted position, the arm 177 may engage the blade holder 121 and cause the blade holder 121 to move from the closed position toward the open position. It will be appreciated that the movement of the actuator 163 from the extended position to the retracted position may move the blade holder 121 only partially from the closed position to the open position. In certain example embodiments, the blade holder 121 may be further moved to the open position by a spring, such as an over-center spring, as described below. Alternatively, in other example embodiments, the blade holder 121 may be grasped by a user and further moved to the open position.

The button 164 may be configured to releasably engage the blade holder 121 when the blade holder 121 is in the closed position. As shown, the button 164 may include a base portion 184, a first protrusion 185 extending laterally from the base portion 184, a second protrusion 186 extending laterally from the base portion 184, and a third protrusion 187 extending rearward from the base portion 184. The base portion 184 may be positioned at least partially within a first recess 188 of the first housing portion 171 and movable therein. The first protrusion 185 may be positioned at least partially within a third aperture 189 of the first housing portion 171 and movable therein. The second protrusion 186 may be positioned at least partially within a first aperture 191 of the first plate 166 and movable therein. The first plate 166 may be attached to the first housing portion 171 by a number of fasteners such that the base portion 184 is maintained within the first recess 188, the first protrusion 185 is maintained within the third aperture 189, and the second protrusion 186 is maintained within the first aperture 191. The button 164 may be movable relative to the housing 161 between an extended position in which the first protrusion 185 is positioned closer to a first end of the third aperture 189 and a retracted position in which the first protrusion 185 is positioned closer to an opposite second end of the third aperture 189. The first spring 165 may be positioned at least partially within the first recess 188 of the first housing portion 171 and configured to bias the button 164 toward the extended position. As shown, the first spring 165 may be positioned at least partially around the third protrusion 187 of the button 164 and held in position by the first plate 166. When the button 164 is in the extended position and the blade holder 121 is in the closed position, the second protrusion 186 of the button 164 may releasably engage a third aperture 192 of the first body portion 128 and prevent rotation of the blade holder 121 from the closed position toward the open position. When the button 164 is in the retracted position, the second protrusion 186 of the button 164 may disengage the third aperture 192, thereby allowing rotation of the blade holder 121 from the closed position toward the open position.

The second plate 167 may be attached to the second housing portion 172 by a number of fasteners. The second plate 167 may include a first aperture 193 and a second aperture 194 extending therethrough. The second end portion 132 of the axle 123 may extend through the first aperture 193. As shown, the second plate 167 may be positioned over a first recess 195 of the second housing portion 172. In certain example embodiments, a spring may be positioned at least partially within the first recess 195 and maintained therein by the second plate 167. The spring may be configured to facilitate movement of the blade holder 121 from the closed position toward the open position. In certain example embodiments, the spring may be an over-center spring configured to activate after the blade holder 121 has moved partially from the closed position toward the open position. In this manner, the spring may cause the blade holder 121 to complete movement from the closed position to the open position. One end of the spring may extend through the second aperture 194 of the second plate 167 and be attached to the blade holder 121. For example, the end of the spring may be received within a second aperture 196 of the second body portion 129. In this manner, movement of the end of the spring during the partial movement of the blade holder 121 from the closed position toward the open position may activate the spring to cause the blade holder 121 to move to the open position.

The leaf spring 168 may be configured to releasably engage the blade holder 121 when the blade holder 121 is in the open position. As shown, the leaf spring 168 may include a base portion 197 and arm 198 extending forward from the base portion 197. The base portion 197 may be attached to the second housing portion 172 by a number of fasteners, and the arm 198 may be free to deflect relative to the base portion 197 and the second housing portion 172. The arm 198 may be configured to move between a retracted position in which the free end of the arm 198 is positioned closer to the second housing portion 172 and an extended position in which the free end of the arm 198 is positioned further away from the second housing portion 172. The arm 198 may be configured to assume the extended position when no external forces are applied thereto. When the blade holder 121 is in the closed position, the arm 198 may engage a lateral side of the second body portion 129 and be deflected to the retracted position. When the blade holder 121 is in the open position, the arm 198 may assume the extended position and engage the bottom side of the second body portion 129. In this manner, the arm 198 may prevent the blade holder 121 from moving from the open position toward the closed position when the arm 198 is in the extended position and the blade holder 121 is in the open position. When the blade holder 121 is in the open position, the arm 198 may be moved by a user from the extended position to the retracted position, thereby allowing the blade holder 121 to be moved from the open position to the closed position.

The housing assembly 160 also may be configured to store one or more spare blades 114 therein. As shown in FIGS. 1A-1L, 1O, and 1P, the housing assembly 160 may include a door 201, a spare blade holder 202, a magnet 203, a first slug 204, a second slug 205, a tab 206, a second spring 207, and a fastener 208. The door 201 may be configured to control access to an interior space of the housing 161 in which the spare blades 114 may be stored. As shown in FIGS. 1O and 1P, the door 201 may include a base portion 211, an arm 212 extending upward from the base portion 211, a pair of apertures 213 defined in the base portion 211, a first protrusion 214 positioned at a free end of the arm 212, and a second protrusion 215 positioned along an intermediate portion of the arm 212. The base portion 211 may be pivotally attached to the housing 161 and positioned at least partially between the first housing portion 171 and the second housing portion 172. In particular, a first protrusion 216 of the first housing portion 171 may be positioned at least partially within one of the apertures 213, and a first protrusion 217 of the second housing portion 172 may be positioned at least partially within the other aperture 213, such that the door 201 is pivotally attached to the housing 161. In this manner, the door 201 may be movable between a closed position in which the door 201 covers a second aperture 218 of the housing 161 and prevents access to the interior space and an open position in which the door 201 exposes the second aperture 218 and allows access to the interior space. The first protrusion 214 may be configured to releasably engage a second protrusion 221 of the first housing portion 171 and a second protrusion 222 of the second housing portion 172 when the door 201 is in the closed position. The protrusions 214, 221, 222 may be formed to provide a snap-fit connection therebetween and to maintain the door 201 in the closed position absent external forces applied to the door 201. The arm 212 may be deflectable relative to the base portion 211 between an extended position and a retracted position. The arm 212 may assume the extended position absent external forces applied to the door 201 and may be moved to the retracted position by a user pressing downward on the arm 212. When the arm 212 is in the retracted position, the first protrusion 214 may disengage the second protrusions 221, 222, thereby allowing the door 201 to move from the closed position to the open position to provide access to the interior space of the housing 161.

The spare blade holder 202 may be positioned at least partially within the interior space of the housing 161 and movable therein. The spare blade holder 202 may be formed as a generally plate-like member configured to hold the spare blades 114 within the interior space. As shown, the spare plate holder 202 may include a wall 224, a shelf 225 extending laterally from the wall 224, a first protrusion 226 extending laterally from the wall 224, a second protrusion 227 extending laterally from the wall 224, a recess 228 defined in the wall 224, and an aperture 229 defined in the wall 224. The spare blade holder 202 may be configured to support one or more of the spare blades 114 thereon and between the spare blade holder 202 and the first housing portion 171. The shelf 225 may be configured to allow the cutting edge of the blade 114 to rest thereon, and the first protrusion 226 may be configured to limit insertion of the blade 114 into the interior space of the housing 161. The second protrusion 227 may be positioned at least partially into the second spring 207. For example, the second spring 207 may be a torsion spring, as shown, and the second protrusion 227 may be positioned at least partially within the coiled portion of the second spring 207 to support the second spring 207 relative to the spare blade holder 202. One of the arms of the second spring 207 may be positioned at least partially within the recess 228 such that the second spring 207 may be loaded and unloaded by movement of the other arm of the second spring 207. The magnet 203 may be positioned at least partially within the aperture 229 and carried thereby.

As described above, the spare blade holder 202 may be movable relative to the housing 161 between a retracted position in which the spare blade holder 202 is positioned entirely within the housing and an extended position in which the spare blade holder 202 extends through the second aperture 218 and is positioned at least partially outside of the housing 161. In particular, the spare blade holder 202 may translate relative to the housing 161 between the retracted position and the extended position. The magnet 203 may cooperate with the first slug 204 and the second slug 205 to hold the spare blade holder 202 in the retracted position and the extended position, respectively. In certain example embodiments, the first slug 204 and the second slug 205 may be formed of a metal that is attracted to the magnet 203. In certain example embodiments, the first slug 204 and the second slug 205 may be magnets that are attracted to the magnet 203. The first slug 204 may be positioned at least partially within a third aperture 231 of the second housing portion 172, and the second slug 205 may be positioned at least partially within a fourth aperture 232 of the second housing portion 172. When the spare blade holder 202 is in the retracted position, magnetic forces between the magnet 203 and the first slug 204 may maintain the position of the spare blade holder 202 relative to the housing 161 absent external forces applied to the spare blade holder 202. When the spare blade holder 202 is in the extended position, magnetic forces between the magnet 203 and the second slug 205 may maintain the position of the spare blade holder 202 relative to the housing 161 absent external forces applied to the spare blade holder 202. The spare blade holder 202 may be moved from the retracted position toward the extended position by pulling the spare blade holder 202 partially out of the housing 161 with sufficient force to overcome the magnetic forces between the magnet 203 and the first slug 204. The spare blade holder 202 may be moved from the extended position toward the retracted position by pushing the spare blade holder 202 into the housing 161 with sufficient force to overcome the magnetic forces between the magnet 203 and the second slug 205. The magnet 203 also may be configured to facilitate retention of one or more spare blades 114 carried by the spare blade holder 202. In particular, the spare blades 114 may be formed of a metal that is attracted to the magnet 203, and magnetic forces between the spare blades 114 and the magnet 203 may maintain a position of the spare blades 114 relative to the spare blade holder 202 absent external forces applied to move the spare blades 114 relative to the spare blade holder 202.

The tab 206 may be attached to the spare blade holder 202 and configured to facilitate movement of the spare blade holder 202 between the retracted position and the extended position. As shown, the tab 206 may include a base portion 234, an arm 235 extending from the base portion 234, and an aperture 236 extending through the base portion 234. The base portion 234 may be pivotally attached to the spare blade holder 202, such that the tab 206 may pivot relative to the spare blade holder 202. In particular, the tab 206 may be movable between a retracted position in which the arm 235 extends substantially upward over a portion of the spare blade holder 202 and an extended position in which the arm 235 extends substantially rearward away from the spare blade holder 202. As shown, one of the arms of the second spring 207 may engage the arm 235 of the spare blade holder 202 and bias the tab 206 toward the extended position. The tab 206 may be attached to the spare blade holder 202 by the fastener 208 extending through the aperture 236 and engaging the spare blade holder 202, with the second spring 207 positioned at least partially between the tab 206 and the spare blade holder 202. When the door 201 is in the closed position, the second protrusion 215 of the door 201 may engage the arm 235 and maintain the tab 206 in the retracted position relative to the spare blade holder 202. When the door 201 is in the open position, the second protrusion 215 may disengage the arm 235 and the second spring 207 may move the tab 206 from the retracted position to the extended position. In this manner, the tab 206 may be easily grasped by a user and pulled to facilitate movement of the spare blade holder 202 from the retracted position to the extended position. When desired, the user may grasp and push the tab 206 to facilitate movement of the spare blade holder 202 from the extended position to the retracted position. Alternatively, the user may simply move the door 201 from the open position to the closed position, thereby causing the door 201 to engage and move the tab 206 from the extended position to the retracted position and further causing the spare blade holder 202 to move from the extended position to the retracted position.

FIGS. 1Q-1T illustrate operation of the knife 100 in moving the blade holder 121 (and the blade 110 retained thereby) relative to the housing 161 between the closed position for storage and the open position for use of the knife 100. As described above, when the blade holder 121 is in the closed position, the button 164 may releasably engage the blade holder 121 and prevent pivotal movement of the blade holder 121 relative to the housing 161. In particular, the second protrusion 186 of the button 164 may engage the third aperture 192 of the first body portion 129 when the blade holder 121 is in the closed position, as shown in FIGS. 1Q and 1R, thereby maintaining the blade holder 121 securely in the closed position. When the button 164 is moved relative to the housing 161 from the extended position to the retracted position, a user may actuate the actuator 163 to move the blade holder 121 from the closed position toward the open position. As described above, when the blade holder 121 is in the closed position, the actuator 163 may be in the extended position with the arm 177 thereof extending through the first aperture 181 of the housing 161, and the actuator 163 may engage the blade holder 121, as shown in FIGS. 1Q and 1R. With the button 164 in the retracted position, the user may press the arm 177 of the actuator 163 into the housing 161, thereby pivoting the actuator 163 about the axle 123. As the actuator 163 pivots from the extended position to the retracted position, the arm 177 thereof may engage the blade holder 121 and pivot the blade holder 121 from the closed position toward the open position. As described above, the pivotal movement of the actuator 163 may cause the blade holder 121 to move only partially from the closed position to the open position. In certain example embodiments, the knife 100 may include a spring, such as an over-center spring, which is activated as the actuator 163 moves from the extended position to the retracted position, and the spring may cause the blade holder 121 to move all the way to the open position, as shown in FIGS. 1S and 1T. Alternatively, after pivoting the actuator 163 from the extended position to the retracted position, the user may grasp and move the blade holder 121 the rest of the way to the open position.

When the blade holder 121 is in the open position, the actuator 163 may remain in the retracted position, with the arm 177 thereof positioned entirely within the housing 161. In this manner, the actuator 163 may be maintained within the housing 161, as shown in FIGS. 1S and 1T. In certain example embodiments, as shown, the button 164 may inhibit the actuator 163 from moving from the retracted position toward the extended position when the blade holder 121 is in the open position. For example, the second protrusion 186 of the button 164 may engage or otherwise block the arm 177 from extending out of the housing 161 due to a force or gravity or movement of the knife 100. When the blade holder 121 is in the open position, the leaf spring 168 may engage the blade holder 121 and prevent the blade holder 121 from moving from the open position toward the closed position. In particular, the arm 198 of the leaf spring 168 may assume the extended position and engage the blade holder 121 when the blade holder 121 is in the open position, thereby maintaining the blade holder 121 in the open position for use of the knife 100. Following use of the knife 100, the blade holder 121 may be moved from the open position back to the closed position for storage. In particular, the arm 198 of the leaf spring 168 may be moved from the extended position to the retracted position such that the arm 198 disengages the blade holder 121. When the arm 198 is in the retracted position, the user may grasp and pivot the blade holder 121 from the open position to the closed position. As the blade holder 121 is pivoted from the open position to the closed position, the blade holder 121 may reengage the arm 177 of the actuator 163, thereby causing the actuator 163 to rotate from the retracted position to the extended position. In certain example embodiments, as the actuator 163 rotates from the retracted position toward the extended position, the actuator 163 may engage the second protrusion 186 of the button 164 and cause the button 164 to move from the extended position toward the retracted position. For example, the actuator 163 may engage a tapered surface of the second protrusion 186, thereby allowing the pivotal movement of the actuator 163 to translate the button 164. In certain example embodiments, as the blade holder 121 rotates from the open position to the closed position, the blade holder 121 may engage the second protrusion 186 of the button 164 and cause the button 164 to move from the extended position toward the retracted position. When the blade holder 121 reaches the closed position, the actuator 163 may again be in the extended position, and the button 164 may be in the extended position, as shown in FIGS. 1Q and 1R.

FIGS. 1U and 1V illustrate operation of the knife 100 in removing the existing blade 110 from the blade holder 121 and replacing the existing blade 110 with a new blade 110. As described above, the blade 110 may be releasably retained at least partially within the blade holder 121 during use of the knife 100. In particular, the axle 123, the button 124, and the rod 126 may cooperate to selectively maintain a position of the blade 110 relative to the blade holder 121. As described above, the second protrusion 143 of the button 124 may releasably engage one of the apertures 112 of the blade 110 to prevent the blade 110 from being removed from the blade holder 121, although the button 124 may disengage the blade 110 when the button 124 is moved from the extended position to the retracted position. When the rod 126 is in the extended position, the rod 126 may prevent the button 124 from moving from the extended position to the retracted position. As described above, the rod 126 may be maintained in the extended position when the blade holder 121 is in the closed position and when the blade holder 121 is in the open position. The rod 126 may move from the extended position only when the blade holder 121 is moved to a partially open position relative to the housing 161, as shown in FIGS. 1U and 1V. In certain example embodiments, the longitudinal axis of the blade holder 121 may be at an angle of approximately 45 degrees relative to the longitudinal axis of the housing 161 when blade holder 121 is in the partially open position, although other angles may be used. When the blade holder 121 is in the partially open position, the rod 126 may be radially aligned with the recess 134 of the flange 133 of the axle 123. In this manner, when the blade holder 121 reaches the partially open position, the first end portion 146 of the rod 126 may move into the recess 134, and the second end portion 147 of the rod 126 may move outside of the first recess 144 of the second housing portion 129. Such movement of the rod 126 may allow the button 124 to be moved from the extended position to the retracted position. Accordingly, when the blade holder 121 is in the partially open position, the user may move the button 124 to the retracted position, thereby causing the second protrusion 143 to disengage the aperture 112 of the blade 110 and allowing the user to remove the blade 110 from the blade holder 121. After removal of the blade 110, the button 124 may be released and may return to the extended position.

After removal of the existing blade 110, a new blade 110 may be inserted into the blade holder 121. The new blade 110 may be inserted into the blade holder 121 when the blade holder 121 is in the partially open position. In certain example embodiments, as shown, the blade 110 may be inserted into the blade holder 121 when the button 124 is in the extended position, such that the user need not move the button 124 to the retracted position. For example, the second protrusion 143 of the button 124 may have a tapered surface, as shown, such that during insertion of the blade 110 into the blade holder 121, the blade 110 may engage the tapered surface and move the button 124 toward the retracted position. When the leading aperture 112 of the blade 110 is aligned with the second protrusion 143, the button 124 may move back to the extended position and the second protrusion 143 thereof may engage the aperture 112. In this manner, the button 124 may retain the new blade 110 with respect to the blade holder 121. The blade holder 121 then may be moved to the open position for use of the knife 100 or to the closed position for storage of the knife 100. As the blade holder 121 is moved away from the partially open position and toward the open position or the closed position, the rod 126 move from the retracted position to the extended position, thereby preventing actuation of the button 124. In this manner, the new blade 110 may be securely retained by the blade holder 121 for subsequent use of the knife 100.

FIGS. 1U-1X illustrate operation of the knife 100 in inserting the spare blade 114 into the interior space of the housing 161, removing the spare blade 114 from the interior space, and storing the spare blade 114 within the interior space. As described above, the door 201 may be moved from the closed position to the open position to expose the second aperture 218 of the housing 161 and access the interior space thereof. The door 201 may be moved from the closed position to the open position by deflecting the arm 212 of the door 201 toward the base portion 211 thereof, such that the first protrusion 214 of the door 201 disengages the first protrusion 216 of the first housing portion 171 and the first protrusion 217 of the second housing portion 172. After disengaging the first protrusion 216, the door 201 may be pivoted from the closed position to the open position, as shown in FIGS. 1U and 1V. As the door 201 is moved to the open position, the tab 206 may move from the retracted position to the extended position, as shown. The user may grasp and pull the tab 206 away from the housing 161, such that the spare blade holder 202 moves from the retracted position toward the extended position. Such pulling may overcome the magnetic forces between the magnet 203 and the first slug 204. As the spare blade holder 202 is moved close to the extended position, magnetic forces between the magnet 203 and the second slug 205 may cause the spare blade holder 202 to snap into place at the extended position. When the spare blade holder 202 is in the extended position, a portion of the spare blade holder 202 and a portion of any spare blades 114 supported thereby may be positioned outside of the housing 161, as shown in FIG. 1V. In this manner, the user may easily grasp and remove one of the spare blades 114 from the interior space of the housing 161, or the user may easily insert one new spare blades 114 into the interior space. As described above, the magnetic forces between the magnet 203 and one or more of the spare blades 114 may releasably retain the spare blades 114 relative to the spare blade holder 202. In particular, absent external forces, the spare blades 114 loaded in the interior space may be held in place relative to the spare blade holder 202 by such magnetic forces. However, the user may grasp and remove one of the spare blades 114 from the spare blade holder 202 by pulling the spare blade 114 and overcoming the magnetic forces between the magnet 203 and the spare blade 114. Further, upon insertion of a new spare blade 114 into the interior space, the magnetic forces between the magnet 203 and the spare blade 114 may hold the spare blade 114 in place relative to the spare blade holder 202. When the user is done accessing the interior space, the spare blade holder 202 may be moved to the retracted position, and the door 201 may be moved to the closed position. In some instances, the user may grasp the tab 206 and push the spare blade holder 202 into the interior space until the spare blade holder 202 reaches the retracted position, and then pivot the door 201 to the closed position such that the first protrusion 214 engages the first protrusion 216 of the first housing portion 171 and the first protrusion 217 of the second housing portion 172. In other instances, the user simply may grasp and pivot the door 201 to the closed position, which may move the tab 206 from the extended position to the retracted position and also move the spare blade holder 202 from the extended position to the retracted position. In this manner, a single action by the user, moving the door 201 to the closed position, may move the tab 206 to the retracted position and also move the spare blade holder 202 to the retracted position.

When the door 201 is in the closed position, the spare blades 114 may be securely retained within the interior space of the housing 161, as shown in FIGS. 1W and 1X. The cutting edges of the spare blades 114 may rest on the shelf 225 of the spare blade holder 202, while the first protrusion 226 thereof and the door 201 may limit translation of the spare blades 114 within the interior space. As described above, the spare blades 114 may be laterally restrained by the wall 224 of the spare blade holder 202 and the first housing portion 171, such that the spare blades 114 do not interfere with movement of the blade holder 121 and the blade 110 between the closed position and the open position.

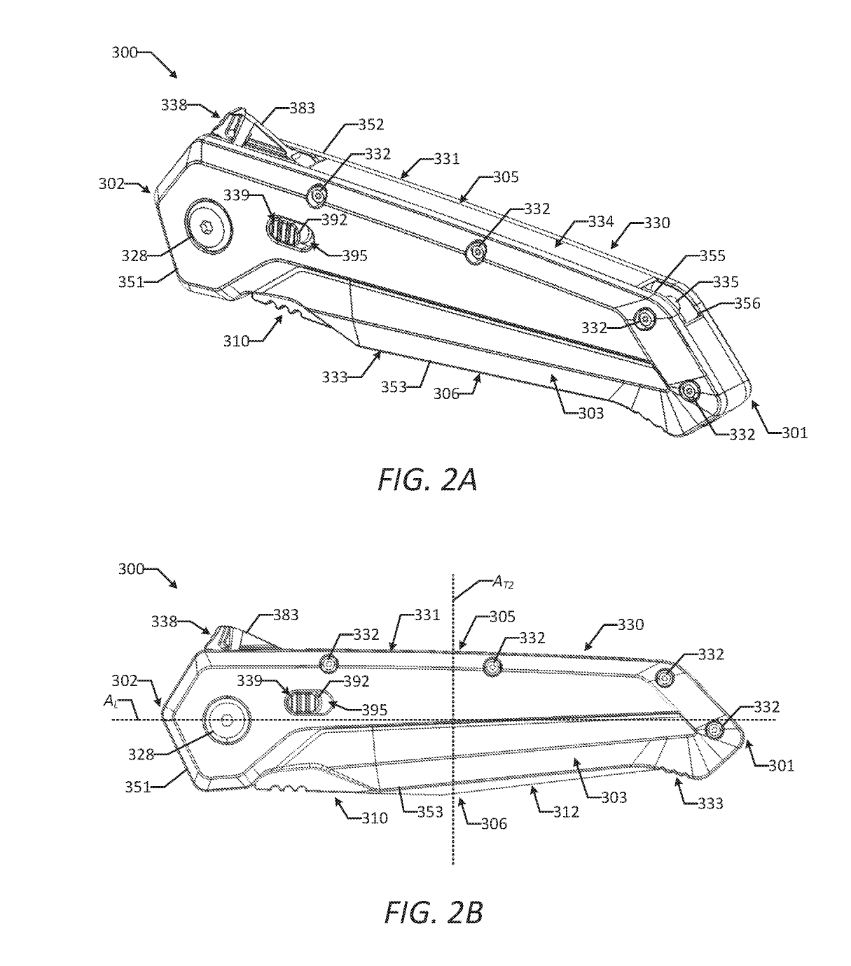

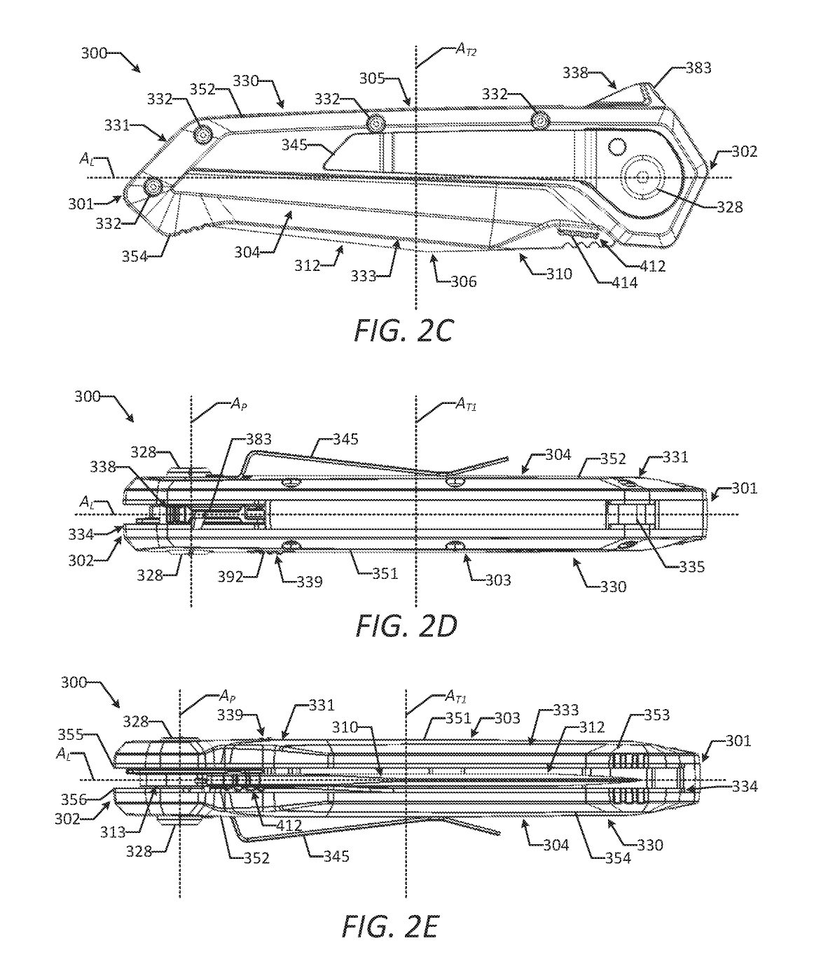

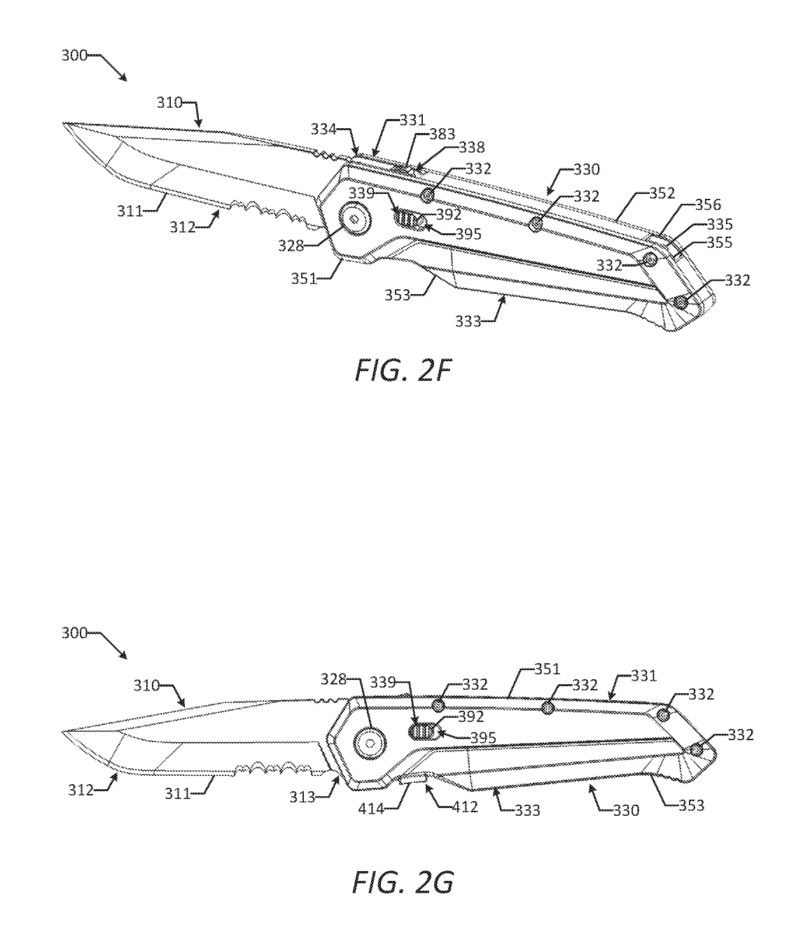

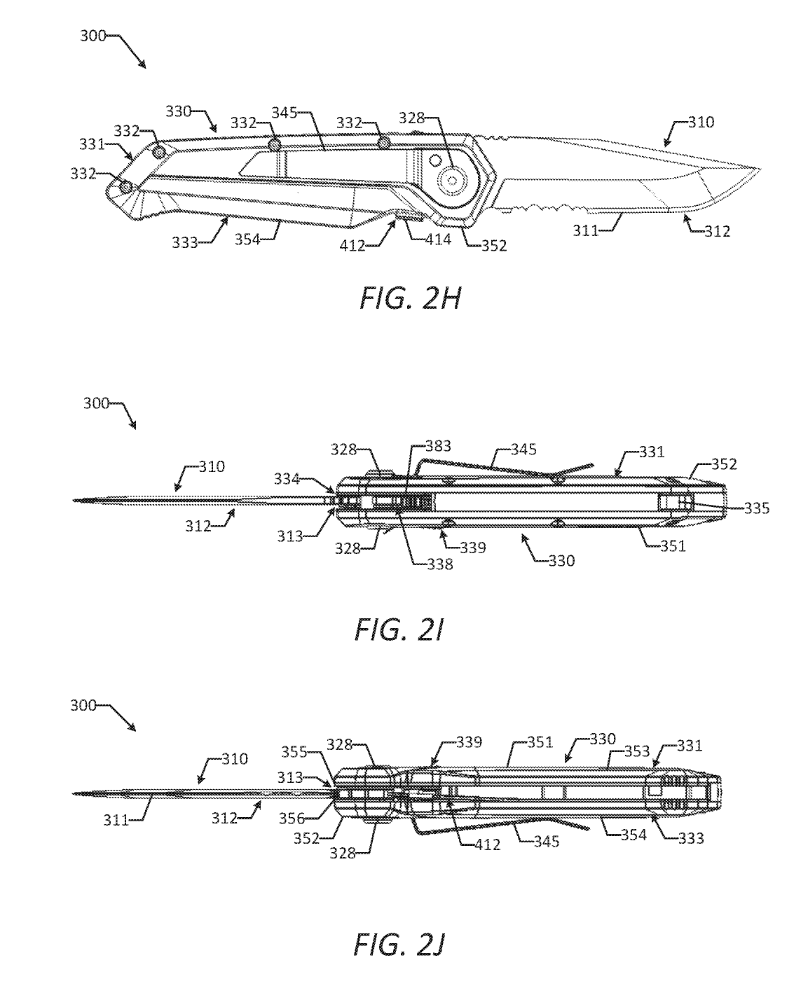

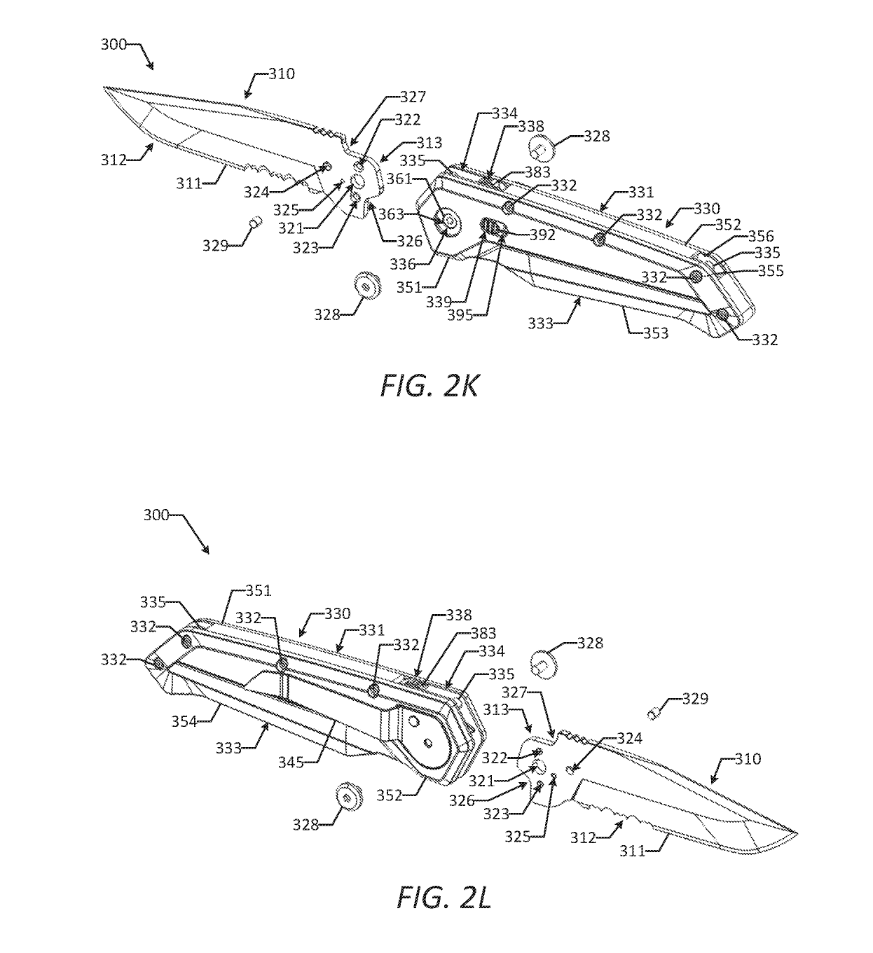

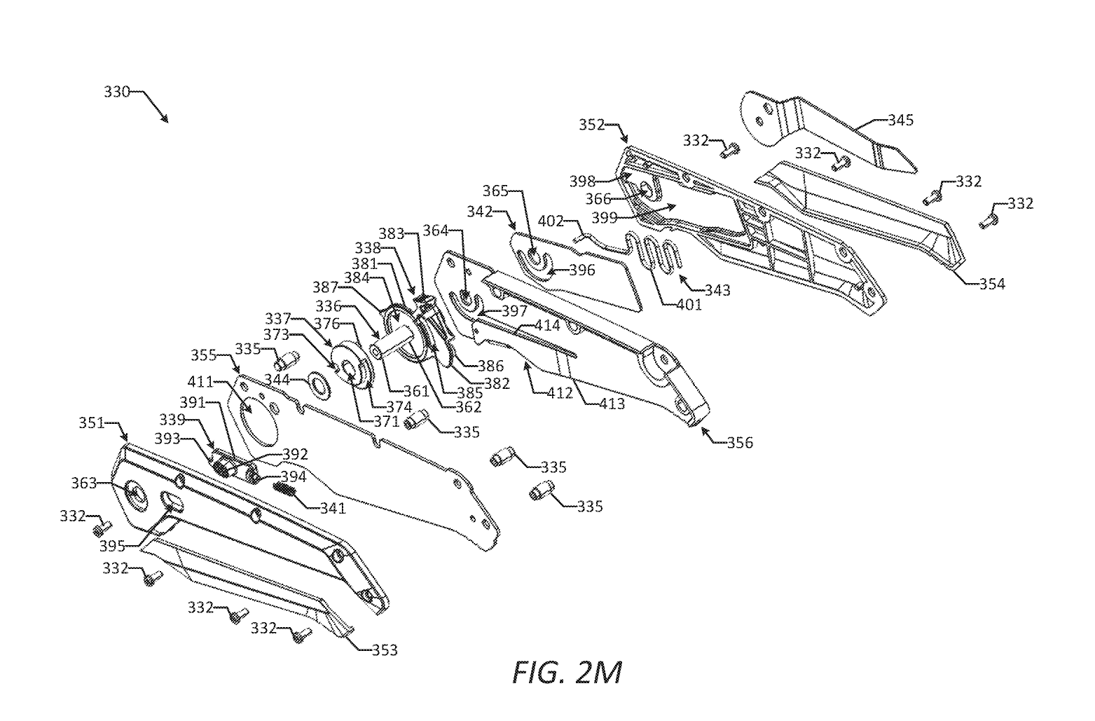

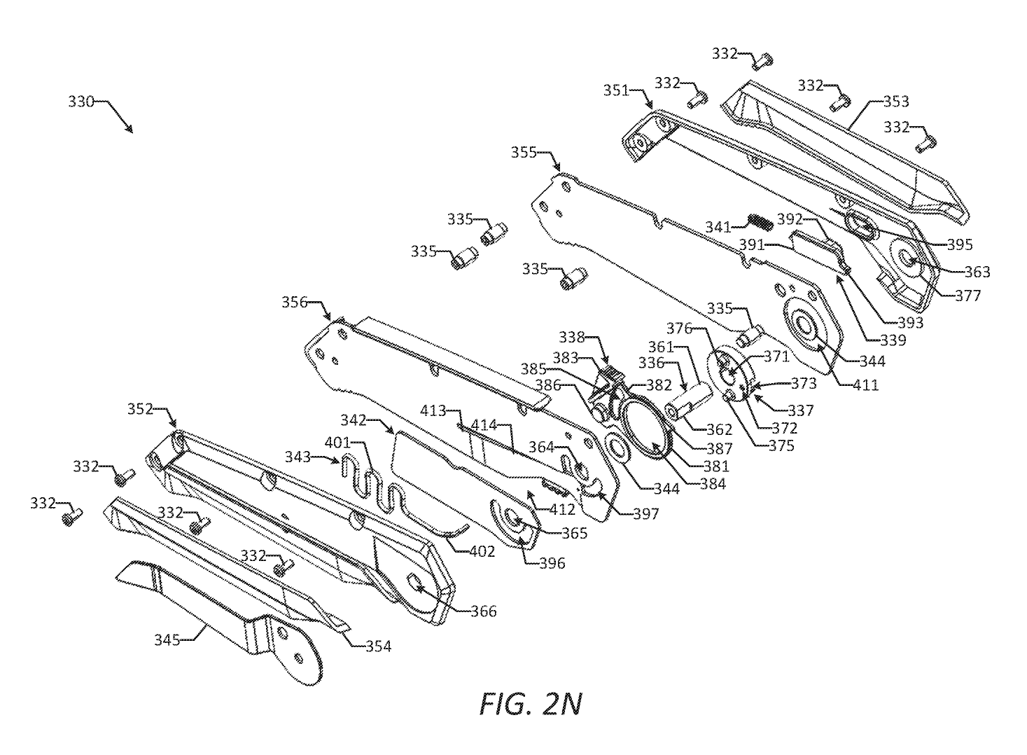

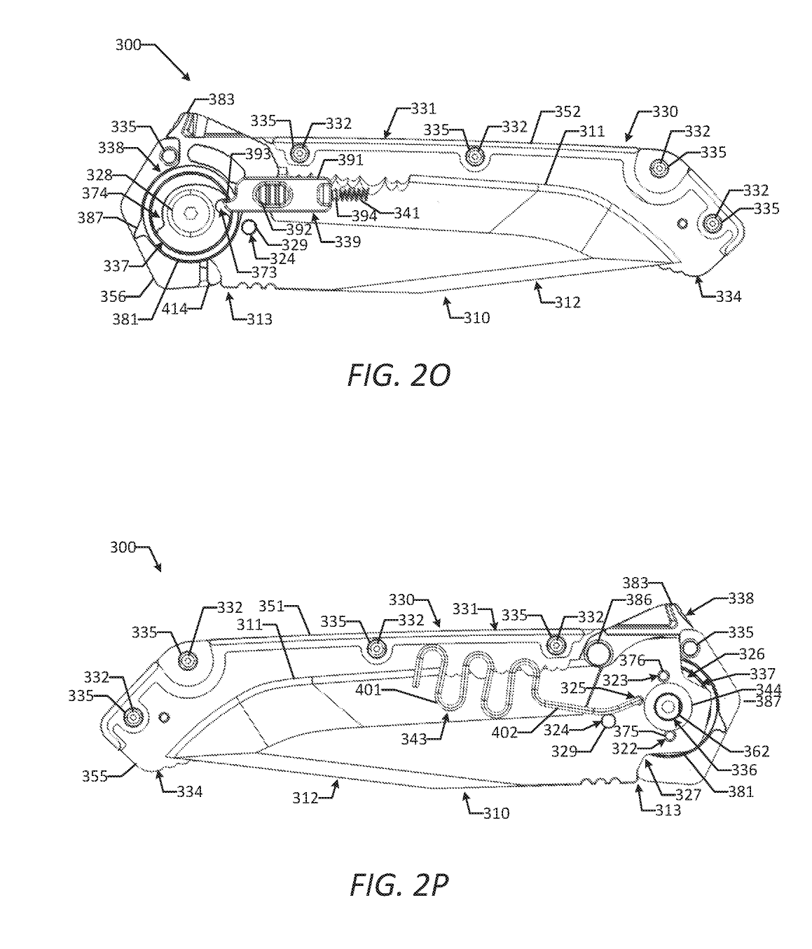

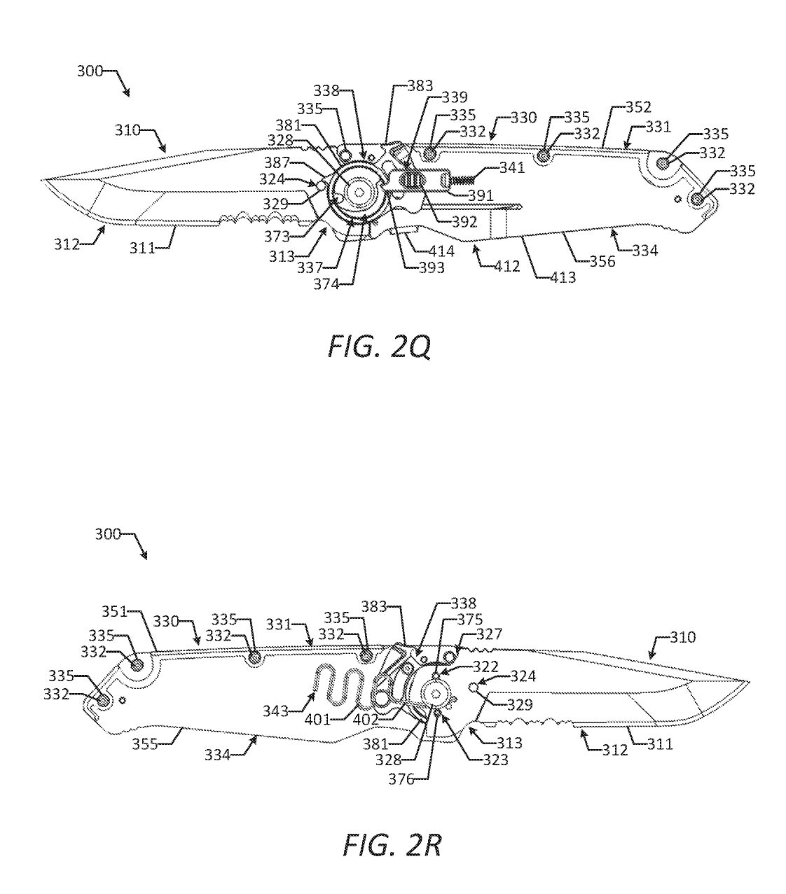

FIGS. 2A-2R illustrate a knife 300 (which also may be referred to as a “assisted opening knife” or a “tactical knife”) as well as individual components and features of the knife 300 in accordance with one or more example embodiments of the disclosure. The knife 300 may be used in various applications to cut different objects or workpieces. As described below, the knife 300 may include a housing, a blade movably attached to the housing, and an actuator for moving the blade relative to the housing from a closed position toward an open position. As compared to certain existing tactical knives, embodiments of the knife 300 described herein may inhibit inadvertent contact with the actuator when the blade is in the open position, thereby minimizing incidence of the blade being unintentionally moved from the open position toward the closed position, may provide a more compact configuration, and/or may be configured in a manner such that actuation of the actuator is straightforward and intuitive for users.

As shown in FIGS. 2A-2R, the example knife 300 may have a generally elongated shape, although various shapes and contours of the knife 300 may be used. The knife 300 may have a length extending in a direction of a longitudinal axis A_{L} of the knife 300, a width extending in a direction of a first transverse axis A_{T1} perpendicular to the longitudinal axis A_{L} of the knife 300, and a height extending in a direction of a second transverse axis A_{T2} perpendicular to each of the longitudinal axis A_{L} and the first transverse axis A_{T1} of the knife 300. As shown, the knife 300 may have a first end 301 (which also may be referred to as a “proximal end” or a “handle end”) and a second end 302 (which also may be referred to as a “distal end” or a “working end”) positioned opposite one another in the direction of the longitudinal axis A_{L} of the knife 300. The knife 300 also may have a first side 303 (which also may be referred to as a “first lateral side”) and a second side 304 (which also may be referred to as a “second lateral side”) positioned opposite one another in the direction of the first transverse axis A_{T1} of the knife 300. Further, the knife 300 may include a third side 305 (which also may be referred to as a “top side”) and a fourth side 306 (which also may be referred to as a “bottom side”) positioned opposite one another in the direction of the second transverse axis A_{T2} of the knife 300. The knife 300 may include a number of components attached, either fixedly or removably, to one another to form the knife 300. In certain example embodiments, as shown, the knife 300 may include a blade 310 movably attached to a housing assembly 330. The blade 310 may be configured to move relative to the housing assembly 330 between a closed position (which also may be referred to as a “storage position”), as shown in FIGS. 2A-2E, and an open position (which also may be referred to as a “deployed position”), as shown in FIGS. 2F-2J. In particular, the blade 310 may be configured to pivot relative to the housing assembly 330 between the closed position and the open position. In this manner, the knife 300 may be movable between a closed configuration in which the blade 310 is in the closed position relative to the housing assembly 330 and an open configuration in which the blade 310 is in the open position relative to the housing assembly 330. It will be appreciated that FIGS. 2A-2R illustrate merely one example embodiment of the knife 300 and that various other configurations of the knife 300 and components thereof may be used.

As shown in FIGS. 2K and 2L, the blade 310 generally may be formed as a tactical blade having an elongated shape, although other shapes and configurations of the blade 310 may be used. The blade 310 may include a cutting edge 311 positioned along the bottom side thereof and extending along a working portion 312 of the blade 310. The cutting edge 311 may be formed as a smooth edge, a serrated edge, or a combination thereof, for cutting different types of objects. The blade 310 also may include a base portion 313 positioned at one end of the blade 310 and configured to cooperate with the housing assembly 330 to facilitate and control movement of the blade 310 relative to the housing assembly 330. As shown, the blade 310 may include a number of apertures defined in the base portion 313 and extending therethrough. In particular, the blade 310 may include a first aperture 321, a second aperture 322, a third aperture 323, a fourth aperture 324, and a fifth aperture 325 defined in the base portion 313. The base portion 313 also may be shaped to define a first recess 326 positioned along the top side of the blade 310, and a second recess 327 positioned along the bottom side of the blade 310. As described below, the apertures 321, 322, 323, 324, 325 and the recesses 326, 327 may be configured to cooperate with additional components of the knife 300 to facilitate and control movement of the blade 310 relative to the housing assembly 330. The blade 310 may be formed of a metal, such as steel, although other materials may be used.

As shown in FIGS. 2A-2J, the blade 310 and the housing assembly 330 may be movably attached to one another such that the blade 310 may pivot between the closed position and the open position about a pivot axis A_{P} of the knife 300. The blade 310 and the housing assembly 330 may be attached to one another by one or more fasteners 328 extending along the pivot axis A_{P}. According to the illustrated embodiment, the knife 300 may include a pair of fasteners 328 formed as screws, although any number of the fasteners 328 and other types of fasteners may be used. As described below, the fasteners 328 may engage and interact with the components of the housing assembly 330 to allow the pivotal movement of the blade 310.

The housing assembly 330 may be configured to control movement of the blade 310 between the closed position and the open position and to receive at least a portion of the blade 310 therein when the blade 310 is in the closed position. As shown in FIGS. 2A-2N, the housing assembly 300 may include a housing 331, a number of fasteners 332, a grip 333, an inner frame 334, a number of pins 335, an axle 336, a coupler 337, an actuator 338, a button 339, a first spring 341, a plate 342, a second spring 343, a number of washers 344, and a clip 345. The housing 331 (which also may be referred to as a “knife housing” or a “knife body”) may be configured to receive at least a portion of the blade 310 therein when the blade 310 is in the closed position. In certain example embodiments, as shown, the housing 331 may include a first housing portion 351 and a second housing portion 352 attached to one another by the fasteners 332 and the pins 335. The fasteners 332 may be formed as screws, although other types of fasteners may be used. As shown, the first housing portion 351 and the second housing portion 352 may define a receptacle therebetween for movably receiving at least a portion of the blade 310 therein. The first housing portion 351 and the second housing portion 352 may include a number of features configured to cooperate with the inner frame 334, the axle 336, the coupler 337, the actuator 338, the button 339, the first spring 341, the plate 342, and the second spring 343, as described below. In certain example embodiments, as shown, the grip 333 may include a first grip portion 353 and a second grip portion 354 attached to the first housing portion 351 and the second housing portion 352, respectively. The grip portions 353, 354 may be formed of a rubber, a plastic, or other material to allow a user to easily grasp and manipulate the housing assembly 330 during use of the knife 300. In certain example embodiments, as shown, the grip portions 353, 354 may be over-molded onto the first housing portion 351 and the second housing portion 352, respectively, although other methods of attachment may be used. In certain example embodiments, as shown, the inner frame 334 may include a first frame portion 355 and a second frame portion 356 attached to the housing 331 by the fasteners 332. The first frame portion 355 and the second frame portion 356 may be at least partially spaced apart from one another by the pins 335 positioned therebetween. The first frame portion 355 and the second frame portion 356 may include a number of features configured to cooperate with the housing 331, the axle 336, the coupler 337, the actuator 338, the button 339, the first spring 341, the plate 342, and the second spring 343, as described below.

As shown in FIGS. 2M and 2N, the axle 336 may be formed as an elongated, generally cylindrical member extending through respective portions of the frame 334, the coupler 337, the actuator 338, the plate 342, and the washers 344. The axle 336 also may extend through the first aperture 321 of the blade 310. The axle 336 may include a first end portion 361 and a second end portion 362 positioned opposite one another. The first end portion 361 may have a cylindrical shape with a circular circumferentially outer surface along the entire circumference thereof. As shown, the first end portion 361 may be positioned at least partially within a first aperture 363 of the first housing portion 351. The second end portion 362 may have a generally cylindrical shape with a circular circumferentially outer surface along a majority of the circumference thereof and a flat surface along a remainder of the circumference of the second end portion 362. As shown, the second end portion 362 may extend through a first aperture 364 of the second frame portion 356 and through a first aperture 365 of the plate 342 and may be positioned at least partially within a first aperture 366 of the second housing portion 352. The first aperture 364 of the second frame portion 356 may have a generally cylindrical shape with a circular circumferentially inner surface along a majority of the circumference thereof and a flat surface along a remainder of the circumference of the first aperture 364. In this manner, the second end portion 362 of the axle 336 may be keyed to the second frame portion 356 such that the axle 336 does not rotate relative to the frame 334 or the housing 331. As shown, the axle 336 may extend along the pivot axis A_{P} of the knife 300 to facilitate pivotal movement of the blade 310 relative to the housing 331 and the frame 334 as well as pivotal movement of the coupler 337 and the actuator 338 relative to the housing 331 and the frame 334, as described below. The axle 336 may be attached to the housing 331 by the fasteners 328 extending through the first housing portion 351 and the second housing portion 352, respectively, and engaging a central aperture of the axle 336. In this manner, the blade 310 may pivot about the axle 336 and the pivot axis A_{P} of the knife 300 between the closed position and the open position.

The coupler 337 may be formed as a generally circular disc-shaped member including a number of features for cooperating with the axle 336, the actuator 338, the button 339, and the blade 310. As shown in FIGS. 2M and 2N, the coupler 337 may include a first aperture 371, a second aperture 372, a first recess 373, a second recess 374, a first protrusion 375, and a second protrusion 376. The first aperture 371 may receive a portion of the axle 336 therein, such that the coupler 337 may pivot about the axle 336 and the pivot axis A_{P} of the knife 300. The second aperture 372 may be spaced apart from the first aperture 371 and offset from the pivot axis A_{P} of the knife 300. As described below, a portion of the second spring 343 may be positioned within the second aperture 372 to facilitate movement of the blade 310 between the closed position and the open position. The first recess 373 may be spaced apart from the first aperture 371 and may be formed as a notch extending from the outer circumferential surface of the coupler 337 toward the first aperture 371. As described below, the first recess 373 may removably receive a portion of the button 339 therein when the blade 310 is in the closed position. The second recess 374 may be spaced apart from the first aperture 371 and may be formed as a groove extending along a portion of the outer circumferential surface of the coupler 337. As shown, the second recess 374 may be circumferentially spaced apart from the first recess 373. As described below, the second recess 374 may removably receive a portion of the button 339 therein when the blade 310 is in the open position. The first protrusion 375 and the second protrusion 376 may be positioned along an opposite side of the coupler 337 relative to the first recess 373 and the second recess 374 and may be spaced apart from the first aperture 371. The first protrusion 375 may be positioned at least partially within the second aperture 322 of the blade 310, and the second protrusion 376 may be positioned at least partially within the third aperture 323 of the blade 310. In this manner, the coupler 337 may pivot along with the blade 310 about the axle 336 as the blade 310 moves between the closed position and the open position. As shown, one of the washers 344 may be positioned over the axle 336 and between a boss 377 of the first housing portion 351 and the side of the coupler 337 having the recesses 373, 374, and the side of the coupler 337 having the protrusions 375, 376 may abut the base portion 313 of the blade 310. The other washer 344 may be positioned over the axles 336 and between the second frame portion 356 and the base portion 313 of the blade 310.

The actuator 338 may be configured to move the blade 310 relative to the housing 331 and the frame 334 from the closed position toward the open position. As shown in FIGS. 2M and 2N, the actuator 338 may include a ring 381, a plate 382 extending away from the ring 381, an arm 383 extending upwardly from the plate 382, a first aperture 384 defined in the ring 381, a second aperture 385 defined in the plate 382, a first protrusion 386 extending from the plate 382, and a second protrusion 387 extending from the ring 381. The ring 381 may have a circular shape with the first aperture 384 extending therethrough, and the ring 381 may be positioned coaxially with the axle 336 for pivotal movement about the pivot axis A_{P}. As shown, the axle 336 may extend through the first aperture 384 of the actuator 338, and the coupler 337 may be positioned at least partially within the first aperture 384. The arm 383 of the actuator 338 may be movably received within the housing 331 and within the frame 334. As shown, the actuator 338 may be configured to pivot relative to the housing 331, the frame 334, and the axle 336 between an extended position in which the arm 383 is positioned at least partially outside of the housing 331 and a retracted position in which the arm 383 is positioned entirely within the housing 331. In this manner, when the actuator 338 is in the extended position, the arm 383 may be exposed and engaged by a user, and when the actuator 338 is in the retracted position, the arm 383 may be positioned entirely between the first housing portion 351 and the second housing portion 352. As further described below, the actuator 338 may be configured to move the blade 310 relative to the housing 331 from the closed position toward the open position. When the actuator 338 is in the extended position and the blade 310 is in the closed position, the actuator 338 may engage the blade 310. In particular, the first protrusion 386 may engage the base portion 313 of the blade 310 when the actuator 338 is in the extended position and the blade 310 is in the closed position. As the actuator 338 pivots about the axle 336 from the extended position to the retracted position, the first protrusion 386 may engage the blade 310 and cause the blade 310 to move from the closed position toward the open position. It will be appreciated that the movement of the actuator 338 from the extended position to the retracted position may move the blade 310 only partially from the closed position to the open position. In certain example embodiments, the blade 310 may be further moved to the open position by a spring, such as the second spring 343, as described below. Alternatively, in other example embodiments, the blade 310 may be grasped by a user and further moved to the open position. When the actuator 338 is in the retracted position and the blade 310 is in the open position, the actuator 338 may engage the blade 310. In certain example embodiments, as shown, the blade 310 may include a pin 329 positioned at least partially within the fourth aperture 324 of the blade 310 and extending laterally therefrom. The second protrusion 387 may engage the pin 329 of the blade 310 when the actuator 338 is in the retracted position and the blade 310 is in the open position. In this manner, the engagement between the second protrusion 387 and the pin 329 may maintain the actuator 338 in the retracted position when the blade 310 is in the open position. In other words, such engagement may prevent the actuator 338 from moving toward the extended position when the blade 310 is in the open position.

The button 339 may be configured to releasably engage the coupler 337 to control pivotal movement of the coupler 337 and the blade 310 relative to the housing 331. As shown, the button 339 may include a base portion 391, a first protrusion 392 extending laterally from the base portion 391, a second protrusion 393 extending forward from the base portion 391, and a third protrusion 394 extending rearward from the base portion 391. The base portion 391 may be positioned at least partially within a space defined between the first housing portion 351 and the first frame portion 355 and movable therein. The first protrusion 392 may be positioned at least partially within a second aperture 395 of the first housing portion 351 and movable therein. The button 339 may be captured between the first housing portion 351 and the first frame portion 355 such that the first protrusion 392 is maintained at least partially within the second aperture 395. The button 339 may be movable relative to the housing 331 between an extended position in which the first protrusion 392 is positioned closer to a first end of the second aperture 395 and a retracted position in which the first protrusion 392 is positioned closer to an opposite second end of the second aperture 395. The first spring 341 may be positioned at least partially within the space between the first housing portion 351 and the first frame portion 355 and configured to bias the button 339 toward the extended position. As shown, the first spring 341 may be positioned at least partially around the third protrusion 391 of the button 339 and held in position between the first housing portion 351 and the first frame portion 355. When the button 339 is in the extended position and the blade 310 is in the closed position, the second protrusion 393 of the button 339 may releasably engage the first recess 373 of the coupler 337, thereby preventing rotation of the coupler 337 and pivotal movement of the blade 310 from the closed position toward the open position. When the button 339 is in the retracted position, the second protrusion 393 may disengage the first recess 373, thereby allowing rotation of the coupler 337 and pivotal movement of the blade 310 from the closed position toward the open position. When the button 339 is in the extended position and the blade 310 is in the open position, the second protrusion 393 may engage the second recess 374 of the coupler 337. As the blade 310 is pivoted from the open position toward the closed position, the second protrusion 393 of the button 339 may move along the second recess 374, and the curved shape of the second recess 374 may move the second protrusion 393 from the extended position toward the retracted position. When the blade 310 reaches the closed position, the second protrusion 393 may again engage the first recess 373 of the coupler 337 and prevent movement of the blade 310 from the closed position toward the open position.

The plate 342 may be configured to control a position and movement of the second spring 343. As shown in FIGS. 2M and 2N, the plate 342 may include the first aperture 365 and a second aperture 396. The second end portion 362 of the axle 336 may extend through the first aperture 365 and into the first aperture 364 of the second housing portion 352. As described below, a portion of the spring 343 may extend through the second aperture 396 of the plate 342 and a second aperture 397 of the second frame portion 356. The second aperture 396 of the plate 342 and the second aperture 397 of the second frame portion 356 each may have a curved shape to accommodate movement of the spring 343. As shown, the plate 342 may be positioned at least partially between the second housing portion 352 and the second frame portion 356, and the second spring 343 may be positioned at least partially between the plate 342 and the second housing portion 352. In particular, the plate 342 may be positioned at least partially within a first recess 398 of the second housing portion 352, and the spring 343 may be positioned at least partially within a second recess 399 of the second housing portion 352 in communication with the first recess 398. In certain example embodiments, as shown, the second spring 343 may be formed as an over-center spring, although other types of springs may be used. The second spring 343 may include a serpentine portion 401 and an elongated arm 402 extending from the serpentine portion 401. The serpentine portion 401 may be positioned within the second recess 399 between the plate 342 and the second housing portion 352, and the arm 402 may extend through the second aperture 396 of the plate 342 and the second aperture 397 of the second frame portion 356. The second spring 343 may be attached to the coupler 337. In particular, the free end of the arm 402 may be positioned at least partially within the second aperture 397 of the coupler 337. As described further below, the second spring 343 may be configured to facilitate movement of the blade 310 from the closed position toward the open position. In certain example embodiments, the second spring 343 may be an over-center spring configured to activate after the blade 310 has moved partially from the closed position toward the open position. In this manner, the arm 402 may move along with the coupler 337 during partial movement of the coupler 337 and the blade 310 toward the open position, and the second spring 343 may cause the blade 310 to complete movement from the closed position to the open position. In other words, movement of the arm 402 of the second spring 343 during the partial movement of the blade 310 from the closed position toward the open position may activate the spring 343 to cause the blade 310 to move to the open position.

The first frame portion 355 and the second frame portion 356 may be configured to contain respective portions of the axle 336, the coupler 337, and the actuator 338 therebetween. As shown, the first frame portion 355 and the second frame portion 356 may be maintained in a spaced apart relationship by the pins 335 positioned therebetween. The first frame portion 355 may include an aperture 411 defined therein. The axle 336 may extend through the aperture 411, and the coupler 337 may be positioned at least partially within the aperture 411. In this manner, the aperture 411 may guide pivotal movement of the coupler 337 about the axle 336. The second frame portion 356 may include a leaf spring 412 configured to releasably engage the blade 310 when the blade 310 is in the open position. The leaf spring 412 may include a base portion 413 attached to a remainder of the second frame portion 356, and an arm 414 extending forward from the base portion 413. The arm 414 may be free to deflect relative to the base portion 413. In particular, the arm 414 may be configured to move between a retracted position in which the free end of the arm 414 is positioned closer to the second housing portion 352 and an extended position in which the free end of the arm 414 is positioned further away from the second housing portion 352. The arm 414 may be configured to assume the extended position when no external forces are applied thereto. When the blade 310 is in the closed position, the arm 414 may engage a lateral side of the 310 and be deflected to the retracted position. When the blade 310 is in the open position, the arm 414 may assume the extended position and engage the first recess 326 of the blade 310. In this manner, the arm 414 may prevent the blade 310 from moving from the open position toward the closed position when the arm 414 is in the extended position and the blade 310 is in the open position. When the blade 310 is in the open position, the arm 414 may be moved by a user from the extended position to the retracted position, thereby allowing the blade 310 to be moved from the open position to the closed position.

The clip 345 may be configured to allow a user to removably attach the knife 300 to a belt, an article of clothing, or another object. As shown, the clip 345 may be formed as a leaf spring to facilitate removably attachment of the knife 300. The clip 345 may be attached to the second housing portion 352 by one of the fasteners 328.

FIGS. 2O-2R illustrate operation of the knife 300 in moving the blade 310 relative to the housing 331 between the closed position for storage and the open position for use of the knife 300. As described above, when the blade 310 is in the closed position, the button 339 may releasably engage the coupler 337 and prevent pivotal movement of the coupler 337 and the blade 310 relative to the housing 331. In particular, the second protrusion 393 of the button 339 may engage the first recess 373 of the coupler 337 when the blade 310 is in the closed position, as shown in FIG. 2O, thereby maintaining the coupler 337 and the blade 310 securely in the closed position. When the button 339 is moved relative to the housing 331 from the extended position to the retracted position, a user may actuate the actuator 338 to move the blade 310 from the closed position toward the open position. As described above, when the blade 310 is in the closed position, the actuator 338 may be in the extended position with the arm 383 thereof extending upward and positioned at least partially outside of the housing 331, and the actuator 338 may engage the blade 310, as shown in FIG. 2P. In particular, the first protrusion 386 of the actuator 338 may engage the blade 310 when the blade 310 is in the closed position and the actuator 338 is in the extended position. With the button 339 in the retracted position, the user may press the arm 383 of the actuator 338 into the housing 331, thereby pivoting the actuator 338 about the axle 336. As the actuator 338 pivots from the extended position to the retracted position, the arm 383 thereof may engage the blade 310 and pivot the blade 310 from the closed position toward the open position. As described above, the pivotal movement of the actuator 338 may cause the blade 310 to move only partially from the closed position to the open position. In certain example embodiments, the second spring 343 may be activated as the actuator 338 moves from the extended position to the retracted position, and the spring 343 may cause the blade 310 to move all the way to the open position, as shown in FIGS. 2Q and 2R. Alternatively, after pivoting the actuator 338 from the extended position to the retracted position, the user may grasp and move the blade 310 the rest of the way to the open position.

When the blade 310 is in the open position, the actuator 338 may remain in the retracted position, with the arm 383 thereof positioned entirely within the housing 331. In this manner, the actuator 338 may be maintained within the housing 331, as shown in FIGS. 2Q and 2R. In certain example embodiments, as shown, when the blade 310 is in the open position, the blade 310 may inhibit the actuator 338 from moving from the retracted position toward the extended position. In particular, the pin 329 of the blade 310 may engage the second protrusion 387 of actuator 338 when the blade 310 is in the open position, thereby preventing the actuator 338 from pivoting toward the extended position. When the blade 310 is in the open position, the leaf spring 412 may engage the blade 310 and prevent the blade 310 from moving from the open position toward the closed position. In particular, the arm 413 of the leaf spring 412 may assume the extended position and engage the first recess 326 of the blade 310 when the blade 310 is in the open position, thereby maintaining the blade 310 in the open position for use of the knife 300. Following use of the knife 300, the blade 310 may be moved from the open position back to the closed position for storage. In particular, the arm 413 of the leaf spring 412 may be moved from the extended position to the retracted position such that the arm 413 disengages the blade 310. When the arm 413 is in the retracted position, the user may grasp and pivot the blade 310 from the open position to the closed position. As the blade 310 is pivoted from the open position to the closed position, the blade 310 may reengage the first protrusion 386 of the actuator 338, thereby causing the actuator 338 to rotate from the retracted position to the extended position. As the blade 310 is pivoted from the open position to the closed position, the coupler 337 may pivot therewith and the second protrusion 393 of the button 339 may move along the second recess 374 of the coupler 337. The curved shape of the second recess 374 may cause the button 339 to move from the extended position toward the retracted position as the coupler 337 pivots with the blade 310 until the first recess 373 of the coupler 337 is aligned with the second protrusion 393 of the button 339. When the blade 310 reaches the closed position, the actuator 338 may again be in the extended position, and the button 339 may be in the extended position, as shown in FIGS. 2O and 2P.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A knife comprising:
a housing;
a blade holder movably attached to the housing and configured to receive a blade at least partially within the blade holder, wherein the blade holder is configured to move relative to the housing between a closed position in which a cutting edge of the blade is positioned entirely within the housing and an open position in which the cutting edge is positioned at least partially outside of the housing; and
an actuator movably attached to the housing and configured to move the blade holder from the closed position toward the open position, wherein the actuator is configured to move relative to the housing between an extended position in which the actuator is positioned at least partially outside of the housing and a retracted position in which the actuator is positioned entirely within the housing.

2. The knife of claim 1, wherein the blade holder is pivotally attached to the housing and configured to pivot relative to the housing between the closed position and the open position.

3. The knife of claim 1, wherein the actuator is pivotally attached to the housing and configured to pivot relative to the housing between the extended position and the retracted position.

4. The knife of claim 1, wherein the actuator is configured to move the blade holder from the closed position toward the open position as the actuator moves from the extended position toward the retracted position.

5. The knife of claim 1, wherein the actuator comprises a ring and an arm, wherein the ring is positioned entirely within the housing when the actuator is in the extended position, and wherein the arm is positioned at least partially outside of the housing when the actuator is in the extended position.

6. The knife of claim 5, wherein the housing comprises an aperture defined in a top surface of the housing, and wherein the arm extends through the aperture when the actuator is in the extended position.

7. The knife of claim 5, wherein the arm is configured to engage the blade holder when the blade holder is in the closed position, and wherein the arm is configured to engage and move the blade holder from the closed position toward the open position as the actuator moves from the extended position toward the retracted position.

8. The knife of claim 1, further comprising a button positioned at least partially within the blade holder, wherein the button is configured to move relative to the blade holder between an extended position and a retracted position, wherein the button is configured to engage and prevent removal of the blade when the button is in the extended position, and wherein the button is configured to disengage and allow removal of the blade when the button is in the retracted position.

9. The knife of claim 8, further comprising a rod positioned at least partially within the blade holder, wherein the rod is configured to move relative to the blade holder between an extended position and a retracted position, wherein the rod is configured to engage and prevent movement of the button from the extended position to the retracted position when the rod is in the extended position, and wherein the rod is configured to disengage and allow movement of the button from the extended position to the retracted position when the rod is in the retracted position.

10. The knife of claim 9, further comprising a spring positioned at least partially within the blade holder and configured to bias the rod toward the retracted position, wherein the rod is configured to assume the extended position when the blade holder is in the closed position and when the blade holder is in the open position, and wherein the rod is configured to assume the retracted position when the rod is in a partially open position between the closed position and the open position.

11. The knife of claim 1, further comprising:
a door movably attached to the housing and positioned about an aperture defined in the housing, wherein the door is configured to move relative to the housing between a closed position in which the door covers the aperture and an open position in which the door exposes the aperture and allows access to an interior space of the housing; and
a spare blade holder movably received within the interior space and configured to support a spare blade therein.

12. The knife of claim 11, wherein the spare blade holder is configured to translate relative to the housing between a retracted position in which the spare blade holder is positioned entirely within the housing and an extended position in which the spare blade holder is positioned at least partially outside of the housing.

13. The knife of claim 12, further comprising:
a first metal slug attached to the housing;
a second metal slug attached to the housing; and
a magnet attached to the spare blade holder, wherein magnetic forces between the magnet and the first metal slug releasably retain the spare blade holder in the retracted position, wherein magnetic forces between the magnet and the second metal slug releasably retain the spare blade holder in the extended position, and wherein the magnet is configured to releasably retain the spare blade relative to the spare blade holder.

14. The knife of claim 12, further comprising:
a tab movably attached to the spare blade holder, wherein the tab is configured to move between a retracted position in which the tab extends over a portion of the spare blade holder and an extended position in which the tab extends away from the spare blade holder; and
a spring attached to the spare blade holder and configured to bias the tab toward the extended position;
wherein the door is configured to move the tab from the extended position to the retracted position when the door is moved from the open position to the closed position; and
wherein the door is configured to move the spare blade holder from the extended position to the retracted position when the door is moved from the open position to the closed position.

15. A knife comprising:
a housing comprising a first aperture defined therein;
a blade comprising a cutting edge;
a blade holder movably attached to the housing and receiving the blade at least partially within the blade holder, wherein the blade holder is configured to move relative to the housing between a closed position in which the cutting edge is positioned entirely within the housing and an open position in which the cutting edge is positioned at least partially outside of the housing; and
an actuator movably attached to the housing and configured to move the blade holder from the closed position toward the open position, wherein the actuator is configured to move relative to the housing between an extended position in which the actuator extends through the first aperture and is positioned at least partially outside of the housing and a retracted position in which the actuator is positioned entirely within the housing.

16. The knife of claim 15, wherein the blade holder is pivotally attached to the housing and configured to pivot relative to the housing between the closed position and the open position, wherein the actuator is pivotally attached to the housing and configured to pivot relative to the housing between the extended position and the retracted position, and wherein the actuator is configured to pivot the blade holder from the closed position toward the open position as the actuator pivots from the extended position toward the retracted position.

17. The knife of claim 15, further comprising:
a door movably attached to the housing and positioned about a second aperture defined in the housing, wherein the door is configured to move relative to the housing between a closed position in which the door covers the second aperture and an open position in which the door exposes the second aperture and allows access to an interior space of the housing;
a spare blade holder movably received within the interior space, wherein the spare blade holder is configured to move relative to the housing between a retracted position in which the spare blade holder is positioned entirely within the housing and an extended position in which the spare blade holder extends through the second aperture and is positioned at least partially outside of the housing; and
a spare blade positioned within the interior space and supported by the spare blade holder.

18. A knife comprising:
a housing;
a blade movably attached to the housing and comprising a cutting edge, wherein the blade is configured to move relative to the housing between a closed position in which the cutting edge is positioned entirely within the housing and an open position in which the cutting edge is positioned at least partially outside of the housing; and
an actuator movably attached to the housing and configured to move the blade from the closed position toward the open position, wherein the actuator is configured to move relative to the housing between an extended position in which the actuator is positioned at least partially outside of the housing and a retracted position in which the actuator is positioned entirely within the housing.

19. The knife of claim 18, wherein the blade is pivotally attached to the housing and configured to pivot relative to the housing between the closed position and the open position, wherein the actuator is pivotally attached to the housing and configured to pivot relative to the housing between the extended position and the retracted position, and wherein the actuator is configured to pivot the blade from the closed position toward the open position as the actuator pivots from the extended position toward the retracted position.

20. The knife of claim 18, wherein the actuator comprises a ring and an arm, wherein the ring is positioned entirely within the housing when the actuator is in the extended position, and wherein the arm is positioned at least partially outside of the housing when the actuator is in the extended position.
